(19) United States
(12) Patent Application Publication
(10) Pub. No.: US 2003/0088702 A1
(43) Pub. Date: May 8, 2003

(54) Address conversion scheme for communications between different address systems

(75) Inventors: Eiki Iwata, Kawasaki (JP); Toshihiko Kurita, Kawasaki (JP); Hirokazu Iwakura, Kawasaki (JP); Hiroyuki Yamashima, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/278,093

(22) Filed: Oct. 23, 2002

(30) Foreign Application Priority Data
Oct. 24, 2001 (JP) 2001-325740
Jun. 18, 2002 (JP) 2002-176788
Oct. 11, 2002 (JP) 2002-298827

(51) Int. Cl. G06F 15/16

(52) U.S. Cl. 709/245; 709/249

(57) ABSTRACT

A communications system performs communications between a plurality of communications networks having different address systems. In the system, a registering part registers a combination of an address or a predetermined application identifier of a terminal on one communications network with an address of a terminal on another communications network, and an address converting part performs address conversion according to the contents of registration made by said registering part.

### BACKGROUND OF THE INVENTION

1. Field of the Invention

The present invention relates to communications between different address systems, and in particular, to address conversion scheme for communications between communications networks having different address systems.

2. The Description of the Related Art

For example, a case of communications between an IPv4 (Internet Protocol Version 4) network and an IPv6 (Internet Protocol Version 6) network having the total allocatable numbers of communications addresses different from each other will now be discussed. In such a case, a system is desired in which communications between an IPv4 communications apparatus and an IPv6 communications apparatus can be performed without being conscious of complicatedness concerning the difference in the address systems, the limited total allocatable number of addresses, and so forth, by applying a gateway apparatus (for example, communications address conversion apparatus) which performs a relay operation of changing a name of a communications apparatus of IPv6 network into a relevant IPv6 communications address.

As a communications method in the related art, a scheme is known to start communications by making an inquiry to a DNS, and, then, using an address from the DNS in response. For example, when communicating from an IPv4 communications apparatus to an IPv6 communications apparatus, a scheme disclosed by Japanese laid-open patent application No. 10-154994 may be used.

The above-mentioned DNS means a domain name system used in a TCP/IP (Transmission Control Protocol/Internet Protocol). In this case, a DNS server has a correspondence table for storing information concerning a correspondence between a host name and an IP address, and a user receives a notice of IP address by sending a host name instead of an IP address itself. And when receiving a mail via the Internet, proper mail acceptance is attained by beforehand registering a receiving person's mail server name into the DNS server.

FIG. 1 shows a diagram of the above-mentioned related art. With this related art, an address conversion system which enables realization of communications between terminals (referred to as “communications apparatuses”, hereinafter) given with addresses according to respective different address systems is performed without beforehand making a large alteration into the existing address systems.

As shown in FIG. 1, on a occasion of performing communications directed to an IPv6 communications apparatus B which operates according to the IPv6 communications system, an IPv4 communications apparatus A which operates according to the IPv4 communications system sends an inquiry to an address conversions apparatus 51 for an address of the IPv6 communications apparatus B. The address conversion apparatus 51 acquires the network address (IPv6 address) of the IPv6 communications apparatus B from a name server (DNS) 52, and returns a temporary IPv4 address corresponding to it to the IPv4 communications apparatus A. The IPv4 communications apparatus A starts communications with the IPv6 communications apparatus B using this temporary IPv4 address.

After a router 53 acquires a correspondence table for the IPv6 address with respect to the temporary IPv4 address from the address conversion apparatus at that time and changing the temporary IPv4 address into the IPv6 address according to this correspondence table, actual communications are established with the communications apparatus B.

That is, in the above-mentioned address conversion system, the address conversion apparatus 51 notifies the temporary IPv4 address to the IPv4 communications apparatus A, and the IPv4 communications apparatus A starts communications based on the temporary IPv4 address. In the router (gateway apparatus) 53 which performs a relay operation between the IPv4 network and the IPv6 network, when a communications start request is received from the IPv4 communications apparatus A, it asks to the apparatus which changes the name of the IPv6 communications apparatus B into the address. The correspondence table for the IPv6 address and temporary IPv4 address, which IPv6 address is the communications partner's actual address, is then acquired, and, after that, the communications partner's temporary IPv4 address is used to be converted into the IPv6 address which is the actual address according to the correspondence table concerned. Thus, the relay operation is performed, and, a communications start request is sent to the IPv6 communications apparatus B, and communications between the IPv4 communications apparatus A and IPv6 communications apparatus B are established.

As well-known, the above-mentioned IPv6 is a next-generation communications protocol which replaces the conventional “IPv4” which is the present standard internet protocol, for the purpose of solving various problems (exhaustion of the Class B, saturation of the path control information, exhaustion of the 32-bit addresses, etc.) concerting the address space of the present Internet communications system.

The above-described scheme using the address conversion apparatus has the following problems. That is, since only a temporary IPv4 address is used for acquiring an IPv6 address, when communications requests directed to a plurality of IPv6 communications apparatuses occurs from a plurality of IPv4 communications apparatuses simultaneously, the corresponding number of temporary IPv4 addresses for the respective destination IPv6 addresses is needed. In fact, as well-known, the total allocatable number of addresses of IPv4 network is very smaller than the total allocatable addresses in the IPv6 network. Therefore, when considering large-scale relay operation between the IPv4 network and IPv6 network, the total allocable number of temporary IPv4 address may become shortage in near future.

### SUMMARY OF THE INVENTION

The present invention has been made for solving this problem, and, is directed to effectively reduction in the number of temporary addresses required to be allocated to addresses of another side of network, thereby enabling a large-scale communications between the two communications networks having different address systems, i.e., IPv4 system and IPv6 system without shortage of address resource.

In order to achieve the above-mentioned object, according to the present invention, an address of a relevant terminal of own network or a relevant predetermined application identifier is made to be registered at the same time of address conversion between communications networks which have different address systems. As a result, even in a case where the total allocatable number of temporarily addresses is not so large to be allocated for addresses in the different address system, it becomes possible to make multiple use of each temporary address by combining the address of the own terminal or relevant application identifier together with the temporary address, and thereby, it is possible to apparently increase the number of times of allocation of the temporary addresses. As a result, it becomes possible to effectively reduce the number of temporary addresses of the own communications network, for example, IPv4, needed for establishing a communications with the other communications network, for example, IPv6.

According to the present invention, since a temporary address used on an occasion of address conversion in a case of communications between communications networks which are different from each other in address rule is registered with a corresponding address or a predetermined application identifier (port number, for example) of a terminal of transmission-source-side communications network. Thereby, it becomes possible to utilize each temporary address many times simultaneously without confusion, and, thus, to utilize a limited available allocatable temporary addresses effectively.

Other objects and further features of the present invention will become more apparent from the following detailed description when read in conjunction with the accompanying drawings.

### BRIEF DESCRIPTION OF THE DRAWINGS

FIG. 1 illustrates a possible problem in communications between different address systems;

FIG. 2 shows a diagram of a communications system according to a first embodiment of the present invention;

FIG. 3 shows a configuration of an IPv4 communications apparatus shown in FIG. 2;

FIG. 4 shows a configuration of a name solution apparatus shown in FIG. 2;

FIG. 5 shows a configuration of a communications address conversion apparatus shown in FIG. 2;

FIGS. 6A and 6B show table data according to the first embodiment of the present invention, FIG. 6A showing a transmission source port number table, and FIG. 6B showing a temporary IPv4 address table;

FIGS. 7A and 7B show other table data according to the first embodiment of the present invention, FIG. 7A showing a correspondence information table with an IPv4 transmission source address, and FIG. 7B showing a correspondence information table with a transmission source port number;

FIG. 8 illustrates a first communications method according to the first embodiment of the present invention;

FIG. 9 shows how to delete correspondence information table data with the IPv4 transmission source address according to the first embodiment of the present invention;

FIG. 10 shows a processing flow chart of the IPv4 communications apparatus according to the first embodiment of the present invention;

FIG. 11 shows a processing flow chart of the name solution apparatus according to the first embodiment of the present invention;

FIG. 12 shows a processing flow chart of the communications address conversion apparatus according to the first embodiment of the present invention;

FIG. 13 illustrates a second communications method according to the first embodiment of the present invention;

FIG. 14 illustrates a method of deleting the correspondence information table data with the transmission source port number according to the second method of the first embodiment of the present invention;

FIG. 15 shows a processing flow chart of the IPv4 communications apparatus in the second method of the first embodiment of the present invention;

FIG. 16 shows a processing flow chart of the name solution apparatus in the second method of the first embodiment of the present invention;

FIG. 17 shows a processing flow chart of the communications address conversion apparatus in the second method of the first embodiment of the present invention;

FIGS. 18 and 19 illustrate possible problems on transmission source address registration;

FIG. 20 shows a system configuration of a second embodiment of the present invention;

FIG. 21 shows a configuration of an IPv4 communications apparatus shown in FIG. 20;

FIG. 22 shows a configuration of a name solution apparatus shown in FIG. 20;

FIG. 23 shows a configuration of a name server shown in FIG. 20;

FIG. 24 shows a configuration of an address conversion apparatus shown in FIG. 20;

FIG. 25 illustrates an address conversion table according to the second embodiment of the present invention;

FIG. 26 illustrates address conversion scheme according to the second embodiment of the present invention;

FIG. 27 shows a flow chart which shows operation of the address conversion apparatus at a time of communications reception from the IPv4 communications apparatus according to the second embodiment of the present invention;

FIG. 28 shows a flow chart which shows operation of the address conversion apparatus at a time of correspondence request reception according to the second embodiment of the present invention;

FIG. 29 shows a flow chart which shows operation of the address conversion apparatus at a time of communications reception from the IPv4 communications apparatus according to the second embodiment of the present invention;

FIG. 30 shows a flow chart of the address conversion apparatus of deleting a table entry, according to the second embodiment of the present invention;

FIG. 31 shows an address conversion table according to a third embodiment of the present invention;

FIG. 32 shows a flow chart of operation of the address conversion apparatus at a time of correspondence request reception according to the third embodiment of the present invention;

FIG. 33 shows a flow chart of operation of the address conversion apparatus at a time of communications reception from the IPv4 communications apparatus according to the third embodiment of the present invention;

FIG. 34 illustrates a fourth embodiment of the present invention;

FIG. 35 shows a functional diagram of a processing load sharing apparatus shown in FIG. 34;

FIG. 36 illustrates a system configuration of the fourth embodiment of the present invention;

FIG. 37 shows a configuration of an address conversion apparatus shown in FIG. 36;

FIG. 38 illustrates a management table of a filtering part shown in FIG. 37;

FIG. 39 shows a system configuration concerning address conversion methods according to the above-mentioned first and second embodiments of the present invention;

FIG. 40 shows a flow chart of the address conversion method according to the first embodiment of the present invention;

FIG. 41 shows a flow chart of the address conversion method according to the second embodiment of the present invention;

FIG. 42 shows a system configuration concerning an address conversion load sharing method according to the fourth embodiment of the present invention;

FIG. 43 shows a configuration of an address conversion apparatus shown in FIG. 42;

FIG. 44 shows a flow chart of operation according to the fourth embodiment of the present invention;

FIG. 45 shows a correspondence request signal according to the fourth embodiment of the present invention;

FIG. 46 shows a management table of a filtering part of the address conversion apparatus according to the fourth embodiment of the present invention;

FIGS. 47 and 48 show a flow chart of an address conversion method according to a fifth embodiment of the present invention:

FIG. 49 illustrates a correspondence request signal according to the fifth embodiment of the present invention;

FIG. 50 illustrates a management table of the filtering part of the address conversion apparatus according to the fifth embodiment of the present invention;

FIGS. 51 and 52 show a flow chart of an address conversion method according to a sixth embodiment of the present invention:

FIG. 53 illustrates a correspondence request signal according to the sixth embodiment of the present invention; and

FIG. 54 shows a configuration of an address conversion apparatus according to a seventh embodiment of the present invention.

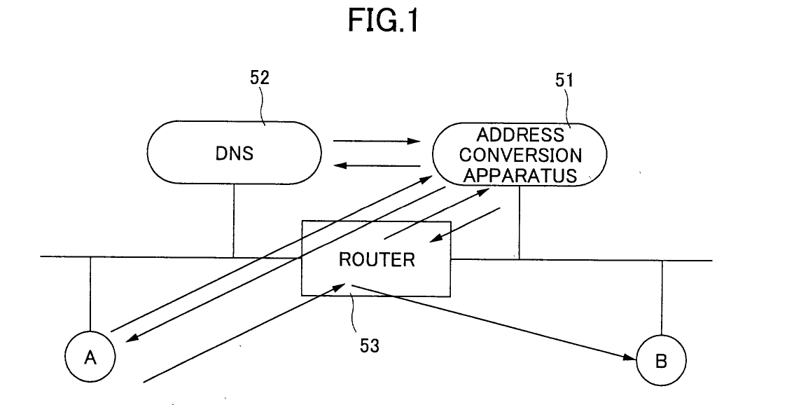

### DETAILED DESCRIPTION OF THE PREFERRED EMBODIMENTS

Hereafter, an embodiment of the present invention will now be described in detail based on the drawings.

First, terms used by the following description will now be descried as follows.

“IPv4 communications apparatus” means a communications apparatus belonging to an IPv4 network 11.

“IPv6 communications apparatus” means a communications apparatus belonging to an IPv6 network 13.

“Address” means a communications address.

A communications system according to a first embodiment of the present invention will now be described.

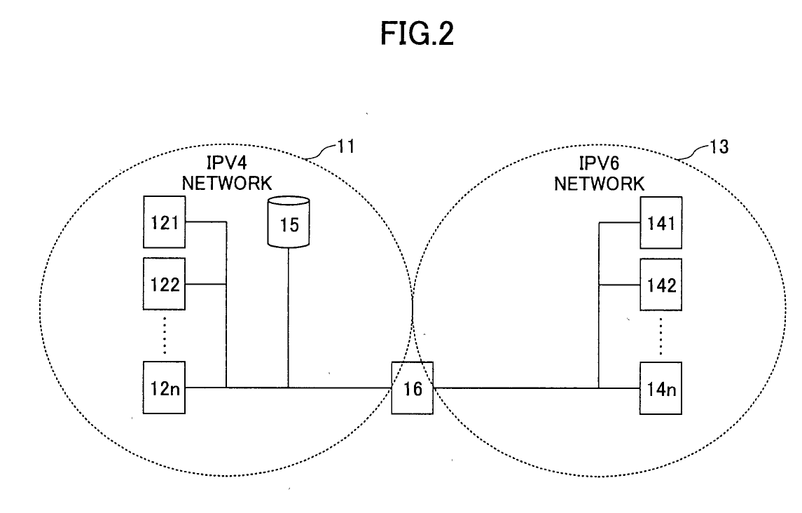

FIG. 2 is a diagram of the communications system concerned. This communications system is an example of a system for communicating from an IPv4 communications apparatus to an IPv6 communications apparatus. In this communications system, while providing a name solution apparatus 15 which changes a given name of an IPv6 communications apparatus into a temporary address effective in the IPv4 network 11, there are a plurality of IPv4 communications apparatuses 121 through 12n. Moreover, a plurality of IPv6 communications apparatuses 141 through 14n are provided in the IPv6 network 13.

A common communications address conversion apparatus 16 (apparatus which functions as a gateway apparatus) which relays communications between the IPv4 network and the IPv6 network is provided in the boundary between the IPv4 network 11 and IPv6 network 13.

The communications circuit (a communications circuit by radio or a communications circuit by cable) is prepared between the name solution apparatus 15, the plurality of IPv4 communications apparatuses 121 through 12n, the plurality of IPv6 communication apparatuses 141 through 14n, and the communications address conversion apparatus 16.

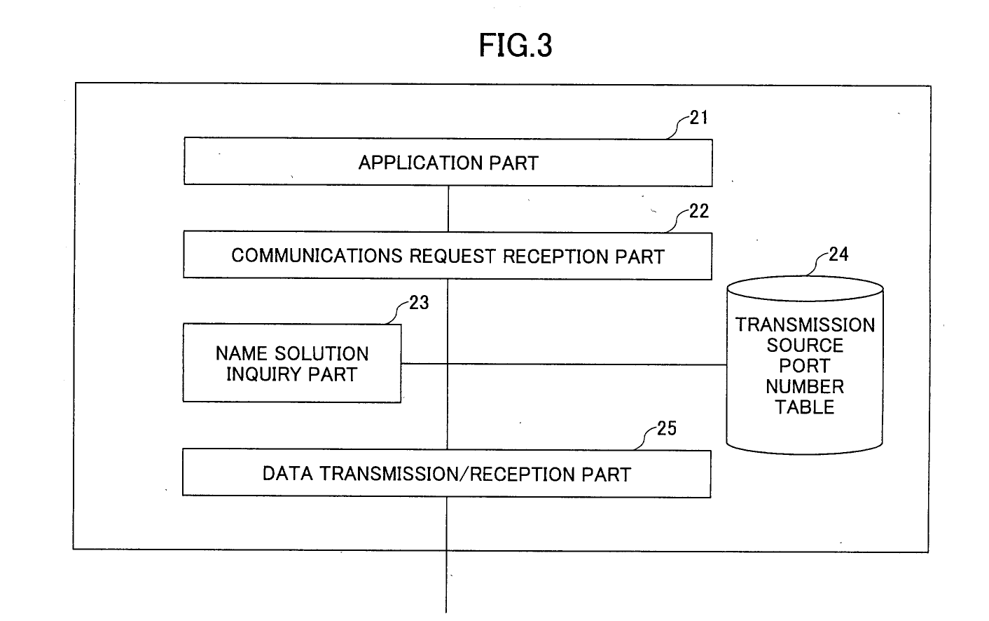

A configuration of each IPv4 communication apparatus will now be described. FIG. 3 is a configuration diagram of each IPv4 communication apparatus. As shown in the figure, the IPv4 communication apparatus includes an application part 21 issuing a communications request; a communications request reception part 22 which receives the communications request directed to an IPv6 communications apparatus, from the application part 21; a name solution inquiry part 23 which asks the name solution apparatus 15 an address of IPv4 based on a host name of the IPv6 communications apparatus; a transmission source port number table 24 for managing transmission source port numbers used at a time of communications, and a data transmission/reception part 25 which performs transmission and reception of data via the communications circuit. The above-mentioned application part 21, the communications request receptionist part 22, the name solution inquiry part 23, and the data transmission/reception part 25 are processing units to be embodied, for example, by execution of software programs by a computer, respectively.

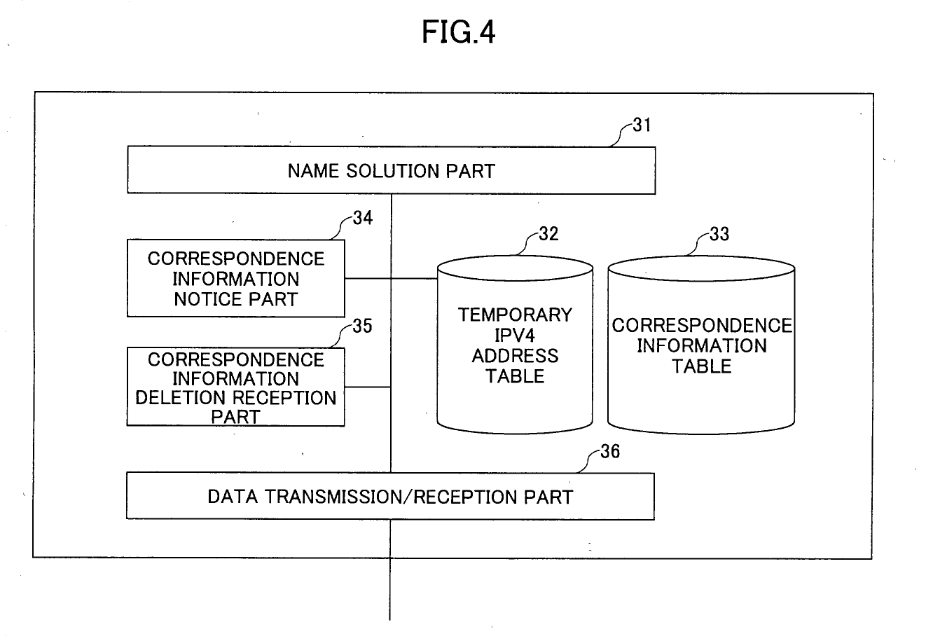

The above-mentioned name solution apparatus will now be described. FIG. 4 is a configuration diagram of the name solution apparatus. As shown in FIG. 4, the name solution apparatus 15 includes: a name solution part 31 which changes a host name given into a relevant IPv6 address; a temporary IPv4 address table 32 for managing destination addresses in the IPv4 address system (referred to as “temporary IPv4 addresses”) to be notified to an asking IPv4 communications apparatus; a correspondence information table 33 for managing IPv6 addresses (referred to as “IPv6 destination addresses” hereinafter), and temporary IPv4 addresses obtained from the above-mentioned temporary IPv4 address table 32, together with the IPv4 addresses in the IPv4 communications apparatuses (referred to as “IPv4 transmission source addresses” hereinafter), or the transmission source port numbers used when communicating, for the temporary IPv4 address, as correspondence information; a correspondence information notification part 34 notifying the IPv6 destination address, temporary IPv4 transmission source address, IPv4 transmission source address, or transmission source port number (referred to as “correspondence information” hereinafter) to the communications address conversion apparatus 16; a correspondence information deletion reception part 35 which receives the correspondence information from the communications address conversion apparatus 16 after the finish of the communications directed to the IPv6 communications apparatus from the IPv4 communications apparatus; and a data transmission/reception part 36 which performs transmission and reception of data via the communications circuit.

The above-mentioned name solution part 31, the correspondence information notification part 34, the correspondence information deletion reception part 35, and the data transmission/reception part 36 are processing units embodied by execution of programs by the computer, respectively, for example.

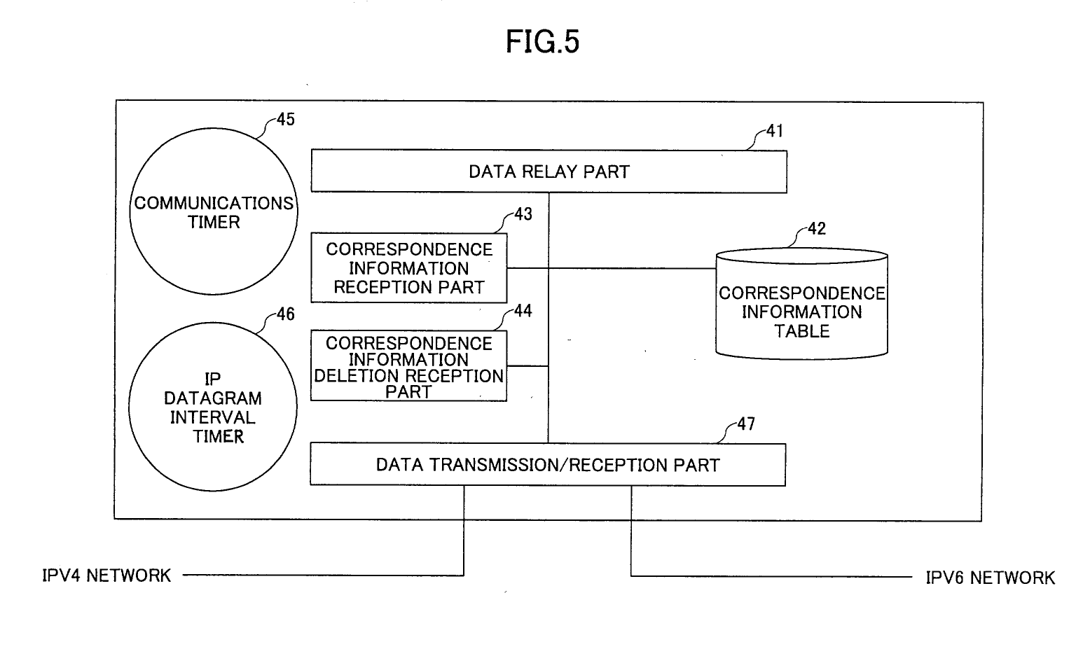

The above-mentioned communications address conversion apparatus will now be described. FIG. 5 is a configuration diagram of the communications address conversion apparatus. As shown in a FIG. 5, the communications address conversion apparatus 16 includes: a data relay part 41 which performs a relay operation for an IPV6 communications apparatus in response to a communications request for a temporary IPv4 address from an IPv4 communications apparatus based on the correspondence information; a correspondence information table 42 which manages the correspondence information; a correspondence information reception part 43 which receives the correspondence information given by the name solution apparatus 15; a correspondence information deletion notice part 44 which notifies the correspondence information to the name solution apparatus 15 after the end of the communications with the IPv6 communications apparatus by the IPv4 communications apparatus; a timer 45 which monitors a communications time; a timer 46 which monitors an interval of IP datagram; and a data transmission/reception part 47 by which communications are enabled between apparatuses belonging to the IPv4 network and IPv6 network.

The above-mentioned data relay part 41 which carries out the relay operation, the correspondence information reception part 43, the correspondence information deletion notice part 44, and the data transmission/reception part 47 are processing units which may be embodied by execution of software programs by a computer, respectively, for example.

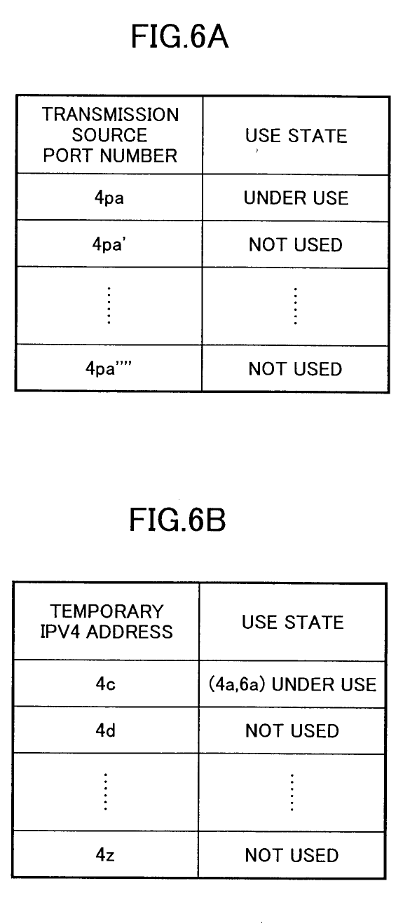

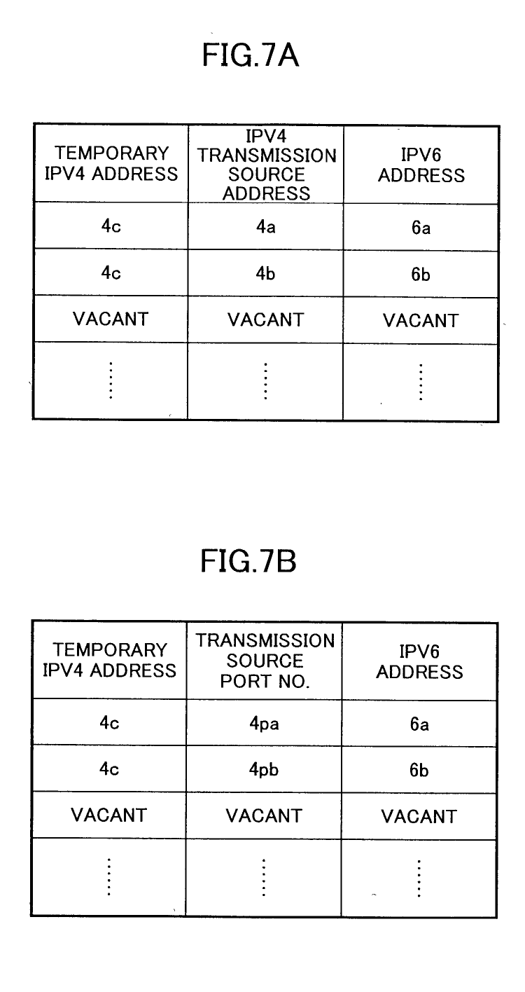

Next, the above-mentioned table data will now be described. FIG. 6A shows a transmission source port number table and FIG. 6B shows a temporary IPv4 address table. Similarly FIG. 7A shows a correspondence information table with IPv4 transmission source address and FIG. 7B shows a correspondence information table with transmission source port number.

The transmission source port number table shown in FIG. 6A is a table configured so that each pair of a transmission source port number and use state information which shows whether or not it is under use can be registered with information concerning a correspondence therebetween. For example, the use state of a port having the transmission source port number 4pa is “under use”, while the use state of a port having the transmission source port number 4pa′ is “not used.” Next, the temporary IPv4 address table shown in FIG. 6B is a table managed by the name solution apparatus 15. On this table, items for “temporary IPv4 address” and “use state” are provided, and data can be registered according to these items. Namely, on this temporary IPv4 address table, the “use state” which shows whether or not it is under use can be registered in a combination with a temporary IPv4 address, an IPv4 transmission source address and an IPv6 address, or a combination of a transmission source port number and an IPv6 address.

For example, the use state on the temporary IPv4 address 4c is “(4a, 6a) under use”, while the use state on the temporary IPv4 address 4c is “not used.”

The correspondence information table with IPv4 transmission source address shown in FIG. 7A is a correspondence information table for managing the correspondence information by the name solution apparatus 15 or the communications address conversion apparatus 16. This table is provided with items for “temporary IPv4 address”, “IPv4 transmission source address” and “IPv6 address”, and data can be registered according to these items. For example, as shown in the figure, temporary IPv4 address: 4c, IPv4 transmission source address: 4a and IPv6 address: 6a, while, in the next entry, IPv4 temporary address: 4c, IPv4 transmission source address 4b and IPv6 address: 6b.

Next, the correspondence information table with the transmission source port number shown in FIG. 7B is a correspondence information table for managing the correspondence information in the name solution apparatus 15 or the communications address conversion apparatus 16. Data can be registered according to respective items, i.e., “temporary IPv4 address”, “transmission source port number”, and “IPv6 address” on this table. In the example shown, temporary IPv4 address: 4c, transmission source port number: 4pa, and IPv6 address: a, while, on the next entry, temporary IPv4 address; 4c, transmission source port number: 4pb and IPv6 address: 6b.

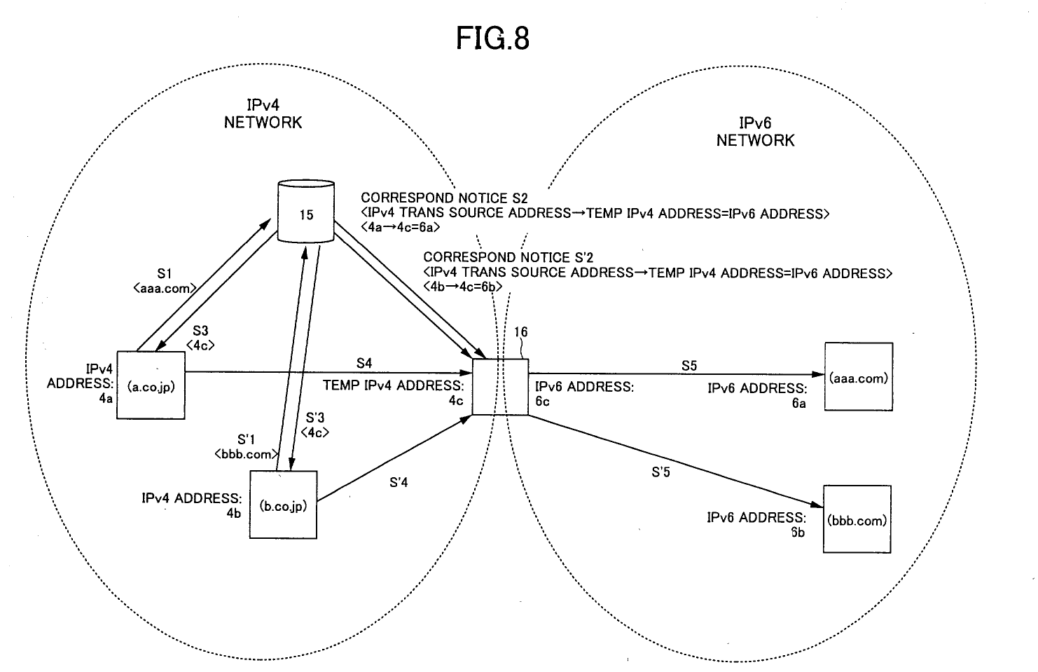

Next, a first communications method which can be carried out in the above-mentioned communications system according to the first embodiment of the present invention will now be described. FIG. 8 is a diagram illustrating this first communications method. The communications method concerned is a method for communicating from an IPv4 communications apparatus to an IPv6 communications apparatus based on the above-mentioned correspondence information table with the IPv4 transmission source address.

In FIG. 8, when communicating from an IPv4 communications apparatus (a.co.jp) to an IPv6 communications apparatus (aaa.com), the IPv4 communications apparatus (a.co.jp) asks as “a name solution request” to the name solution apparatus 15 for a temporary IPv4 address to “aaa.com” which is the name of the IPv6 communications apparatus (aaa.com) concerned (in a step S1 of FIG. 8). The name solution apparatus 15 which has received the name solution request from the IPv4 communications apparatus (a.co.jp) obtains an IPv4 address “4a” of the IPv4 communications apparatus (a.co.jp), and an IPv6 address “6a” of (aaa.com) which is the name of the IPv6 communications apparatus aaa.com in a predetermined manner. Then, a setting is made as “4a and 6a under use” which means that the IPv4 address 4a and the IPv6 address 6a are under use, for the temporary IPv4 address 4c selected, which has been vacant, from the temporary IPv4 address table 32 (see FIG. 4 and FIG. 6B).

Next, the above-mentioned IPv4 transmission source address 4a, temporary IPv4 address 4c, and IPv6 address 6a are saved to the correspondence information table 33 with the IPv4 transmission source address (see FIG. 4 and FIG. 7A). Moreover, this correspondence information concerned is also notified to the communications address conversion apparatus 16 (in a step S2 of FIG. 8). The communications address conversion apparatus 16 to which the correspondence information concerned was notified saves the correspondence information concerned to the correspondence information table with the IPv4 transmission source address (FIG. 7A). The name solution apparatus 15 then transmits the temporary IPv4 address “4c” as a reply to the name solution request from the IPv4 communications apparatus a.co.jp, after notifying the correspondence information concerned to the communications address conversion apparatus 16 (in a step S3 of FIG. 8).

The IPv4 communications apparatus a.co.jp which obtained the reply for the name solution request uses the temporary IPv4 address 4c concerned, and thus starts communications directly with the communications address conversion apparatus 16 (in a step S4 of FIG. 8). In the communications address conversion apparatus 16, “temporary IPv4 address 4c” as transmission destination address and “IPv4 transmission source address 4a” as “transmission source address” are read from the signal concerned received from the IPv4 communications apparatus a.co.jp.

Next, “6a” is obtained as the IPv6 address as a result of searching the correspondence information table (see FIG. 7A) with the transmission destination address 4c and the transmission source address 4a as key information. The communications address conversion apparatus 16 can relay the signal received from the IPv4 communications apparatus a.co.jp to the corresponding IPv6 communications apparatus aaa.com by using the thus-obtained IPv6 address 6a concerned (in a step S5 of FIG. 8).

Also, in a case where another communications request for an IPv6 communications apparatus (bbb.com) occurs from another IPv4 communications apparatus (b.co.jp) while the communications from the IPv4 communications apparatus a.co.jp to the IPv6 communications apparatus aaa.com is on operation, the same temporary IPv4 address “4c” may be chosen for example same as in the communications starting process on the above-mentioned IPv4 communications apparatus (a.co.jp), and then, new communications are started by using this temporary address “4c” (in steps S′1 and S′5 of FTG. 8) again. However, when the temporary IPv4 address “4c” is obtained, the use state of temporary IPv4 address “4c” has been already set as“4a, 6a under use” by the above-mentioned processing as mentioned above (FIG. 6B). In this case, it can be determined that this use state “4a, 6a” is not coincide with the new communications for (4b, 6b) requested by the new IPv4 transmission source “4b” for the IPv6 address “6b.” Therefore, the same address “4c” can be chosen again as the temporary IPv4 address.

That is, according to this scheme, for each temporary IPv4 address, in case registration is made, IPv4 transmission source address and IPv6 transmission destination address in connection with the communications concerned are registered together. Consequently, the same temporary IPv4 address can be used for another occasion of communications on which an IPv4 transmission source address and an IPv6 transmission destination address in connection with the new occasion of communications concerned differ from the already registered ones. That is, since a temporary IPv4 address is registered combining a related IPv4 transmission source address and a related IPv6 transmission destination address together, duplicate use of the same temporary IPv4 address is allowed. Consequently, by this method, effective use of temporary IPv4 addresses is attained. Accordingly, it becomes possible to simultaneously respond to the number of communications requests several times the number of the actual total available number of the temporary addresses.

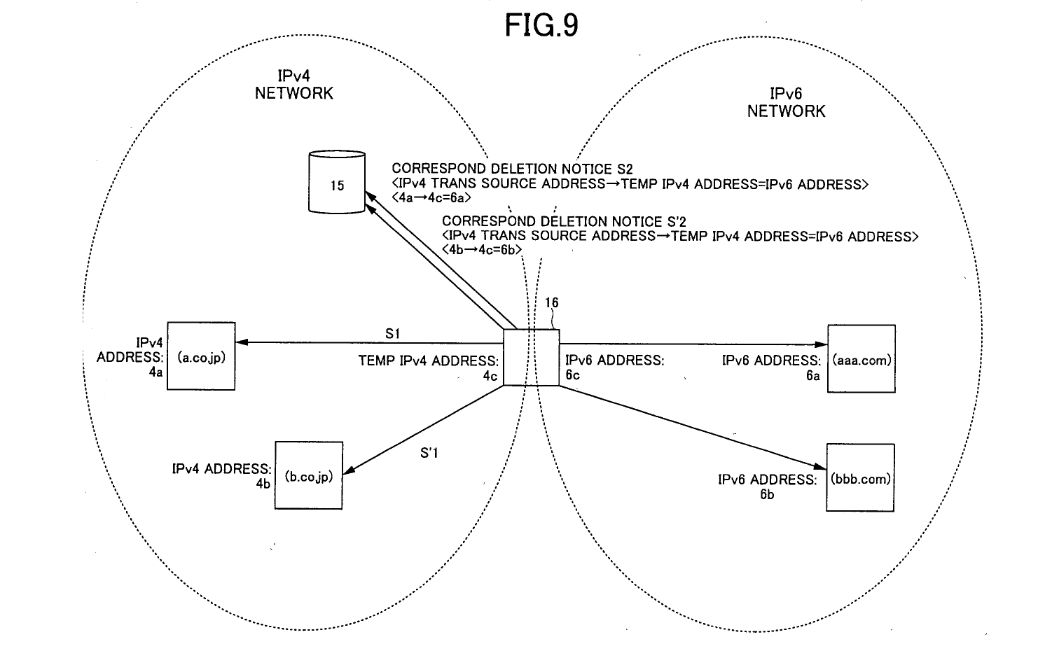

Next, how to delete correspondence information, once registered, from the correspondence information table with the IPv4 transmission source address will now be described. FIG. 9 is a diagram showing how to delete from the correspondence information table with the IPv4 transmission source address. This method is a method for deleting the correspondence information concerned after the end of the communications with the IPv6 communications apparatus started as described above based on the correspondence information table with the IPv4 transmission source address (FIG. 7A) from the IPv4 communications apparatus. As a result of such deletion, it is possible to create a state such that the temporary IPv4 address can be reused freely.

As shown in FIG. 9, when communications are started from the IPv4 communications apparatus a.co.jp to the IPv6 communications apparatus aaa.com (in a step S1 FIG. 9), with the communications address conversion apparatus 16, the timer 45 (see FIG. 5) which monitors the above-mentioned communications time, and the timer 46 which monitors the interval of IP datagram are started. Whenever the timer which monitors the interval of IP datagram receives an IP datagram, it resets the measurement value once, and, thus, monitors the interval on the latest IP datagram.

For example, in case a deadline time of the timer which monitors the communications time is set as 5 minutes while a deadline time of the timer which monitors the interval of TP datagram is set as 5 seconds, when the measurement value of the timer which monitors the communications time passes 5 minutes, or when the measurement value of the timer which monitors the interval of IP datagram passes 5 seconds, it is determined that the occasion of communications concerned are finished. Then, the correspondence information concerned is deleted from the correspondence information table with the IPv4 transmission source address currently held in the communications address conversion apparatus 16. Moreover, a notice of correspondence information deletion for deleting the above-mentioned correspondence information is sent out from the communications address conversion apparatus 16 to the name solution apparatus 15 simultaneously (in a step S2 of FIG. 9). The name solution apparatus 15 having the correspondence information concerned notified then deletes the corresponding correspondence information from the own correspondence information table with the IPv4 transmission source address.

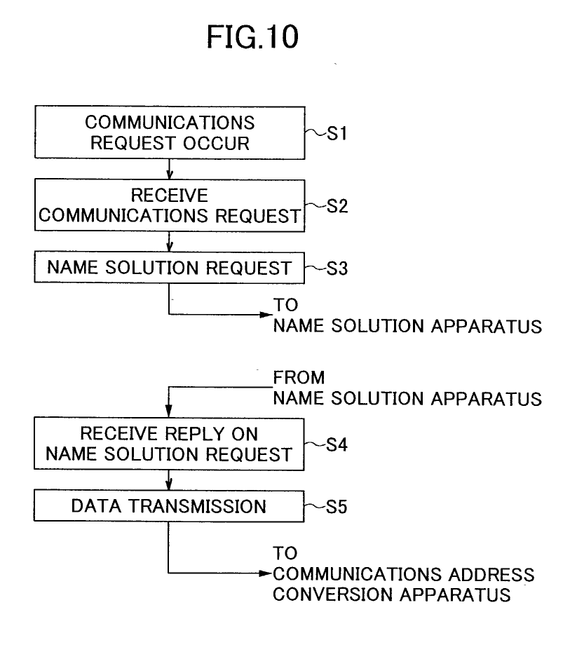

Next, processing performed by each apparatus will now be described in detail. First, processing of each IPv4 communications apparatus will now be described. FIG. 10 shows a processing flow chart of each IPv4 communications apparatus. When a communications request for an IPv6 communications apparatus aaa.com occurs from an IPv4 communications apparatus (in a step S1), the communications are received in the communications request reception part 22 (in a step S2), and the name solution request for the IPv6 communications apparatus aaa.com to the name solution apparatus 15 is issued from the name solution inquiry part 23 to the data transmission/reception part 25 (in a step S3). After that, the data transmission/reception part 25 receives a reply on the name solution request from the name solution apparatus 15 (in a step S4), a temporary IPv4 address is read from the reply in the name solution inquiry part 23, and then, data transmission using the temporary IPv4 address is made from the communications request reception part 22 to the data transmission/reception part 25 (in a step S5).

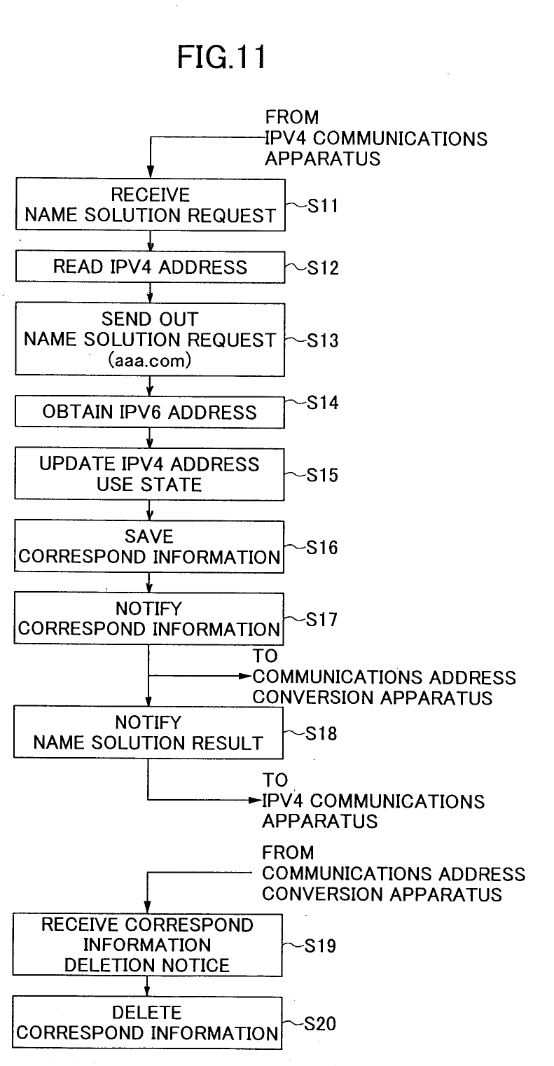

Next, processing of the name solution apparatus will now be described. FIG. 11 shows a processing flow chart on the name solution apparatus. When the name solution request from the IPv4 communications apparatus is received in the data transmission/reception part 36 of the name solution apparatus 15 (in a step S11), the name solution request (aaa.com) for an IPv6 communications apparatus is read out from the received signal (in a step S12), and the name solution request for the relevant IPv6 communications apparatus (aaa.com) is transferred to the data transmission/reception part 36 (in a step S13). The predetermined name solution table is searched by the name solution part 31 by using the name solution request concerned as key information, and thus, the IPv6 address of the relevant IPv6 communications apparatus is obtained (in a step S14).

Then, setting is made as “4a and 6a under use” in the temporary IPv4 address table as the use state of the temporary IPv4 address “4c” concerned (in a step S15). Further, in the correspondence information table with the IPv4 transmission source address, the three items, i.e., the IPv4 address of the IPv4 communications apparatus concerned, the IPv6 address of the IPv6 communications apparatus, and the temporary IPv4 address are saved as the correspondence information (in a step S16). Then, the correspondence information notice part 34 makes a transmission request directed to the communications address conversion apparatus 16 for the above-mentioned correspondence information to the data transmission/reception part 36 (in a step S17). Next, the name solution part 31 makes a transmission request directed to the data transmission/reception part 36 for the temporary IPv4 address concerned as a reply on the name solution request made from the IPv4 communications apparatus (in a step S18).

On the other hand, in the data transmission/reception part 36 of the name solution apparatus 15, when “notice of correspondence information deletion” mentioned above is received from the communications address conversion apparatus 16 (in a step S19), this is sent to the information deletion reception part 34, and, based on the notified correspondence information, the relevant correspondence information is deleted from the correspondence information table (in a step S20).

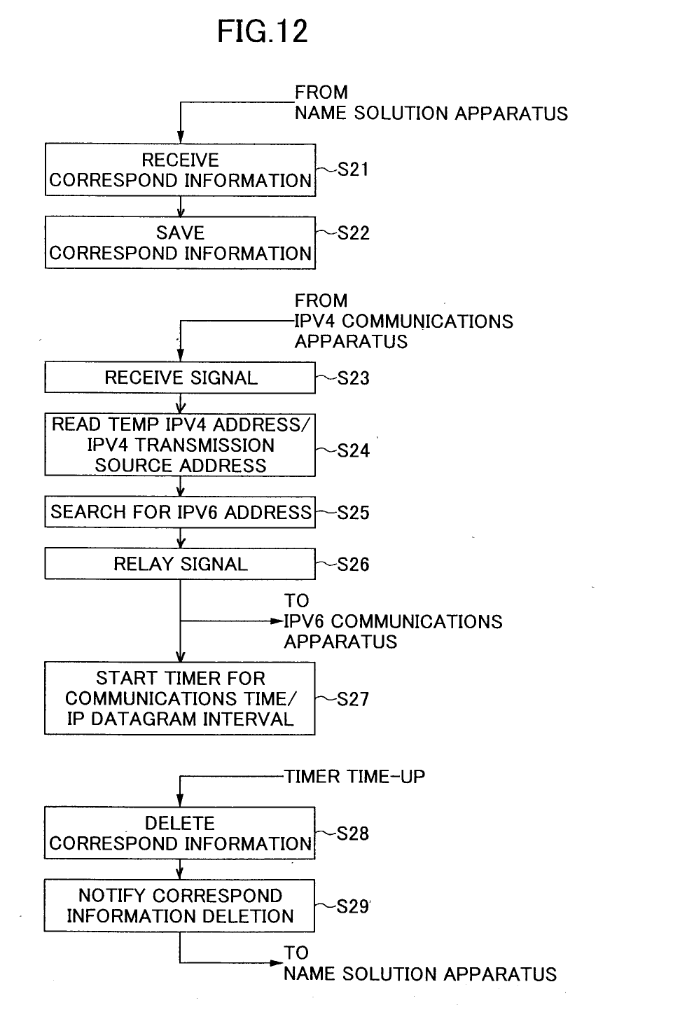

Next, processing of the communications address conversion apparatus will now be described. FIG. 12 shows a processing flow chart of the communications address conversion apparatus. In the data transmission/reception part 47 of the communications address conversion apparatus 16, when the above-mentioned correspondence information is received from the name solution apparatus 15 (in a step S21), the correspondence information concerned is read by the correspondence information reception part 43, and it is saved into the correspondence information table 42 (in a step S22).

Then, in the data transmission/reception part 47 of the communications address conversion apparatus 16, when the signal directed to the temporary IPv4 address is received from the IPv4 communications apparatus (in a step S23), the temporary IPv4 address and the IPv4 transmission source address are read out therefrom (in a step S24), and these temporary IPv4 address and IPv4 transmission source address are used as key information in searching for the IPv6 address from the correspondence information table 42 (in a step S25). Next, the signal received from the IPv4 communications apparatus is relayed using the IPv6 address thus obtained (in a step S26). At this time, the timer which monitors the communications time, and the timer which monitors the interval of IP datagram are started (in a step S27). And when the timer which monitors the interval of IP datagram or the timer which monitors the communications time measures into the time-up value, the correspondence information in connection with the communications monitored by the timer is deleted from the correspondence information table 42 (in a step S28). Next, from the correspondence information deletion notice part 44, the notice of correspondence information deletion is sent to the data transmission/reception part 47 for the name solution apparatus 15 (in a step S29).

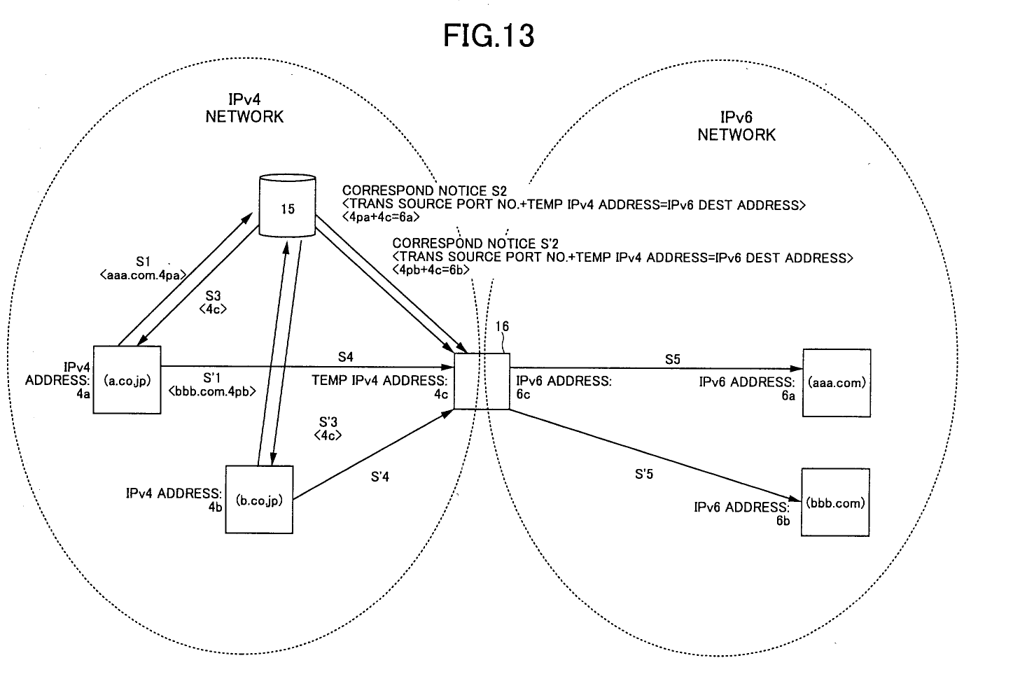

Next, a second communications method which may instead be performed by the first embodiment of the present invention will now be described. FIG. 13 is a diagram of the second communications method according to the first embodiment of the present invention. The communications method concerned is a method of performing communications to an IPv6 communications apparatus from an IPv4 communications apparatus based on the correspondence information table with the “transmission source port number.”

For example, when communicating from an IPv4 communications apparatus “a.co.jp” to an IPv6 communications apparatus “aaa.com” as in the above-mentioned first method, the IPv4 communications apparatus a.co.jp asks a temporary IPv4 address for “aaa.com” which is a name of the IPv6 communications apparatus “aaa.com” as a name solution request to the name solution apparatus 15 (in a step S1 of FIG. 13). At this time, the IPv4 communications apparatus a.co.jp notifies a port number 4pa to the name solution apparatus 15, which port number corresponds to a transmission source port (or an application identifier) used by this IPv4 communications apparatus in the communications at this time with the IPv6 communications apparatus aaa.com.

The name solution apparatus 15 which has received the name solution request from the IPv4 communications apparatus a.co.jp obtains the IPv4 address “4a” of the IPv4 communications apparatus a.co.jp, and the IPv6 address “6a” of the IPv6 communications apparatus aaa.com. And a temporary IPv4 address which is vacant in the temporary address table currently held, for example, “4c”, is chosen therefrom, and setting is made as “4pa and 6a under use” there which means that the relevant temporary IPv4 address 4c is under use in connection with the transmission source port number 4pa and the IPv6 address 6a.

Next, the transmission source port number 4pa, temporary IPv4 address 4c, and IPv6 address 6a are saved in “the correspondence information table with the transmission source port number”. The correspondence information concerned is also notified to the communications address conversion apparatus 16 (in a step S2 of FIG. 13). The communications address conversion apparatus 16 having the correspondence information notified thereto then saves this correspondence information to “the correspondence information table with the transmission source port number” there too.

The name solution apparatus 15 transmits the temporary IPv4 address “4c” as a reply to the name solution request from the IPv4 communications 0apparatus a.co.jp, after notifying the correspondence information concerned to the communications address conversion apparatus 16 (in a step S3 of FIG. 13). The IPv4 communications apparatus a.co.jp which has obtained the reply to the name solution request uses the thus-obtained temporary IPv4 address 4c, and starts communications directed to the communications address conversion apparatus 16 (in a step S4 of FIG. 13).

In the communications address conversion apparatus 16, the temporary IPv4 address 4c and the transmission source port number 4pa are read from the signal then received from the IPv4 communications apparatus a.co.jp. Then, the temporary IPv4 address 4c and transmission source port number 4pa are used as a key, the correspondence information table is searched, and thus, the corresponding IPv6 address 6a is obtained therefrom. As a result, the communications address conversion apparatus 16 becomes possible to relay the signal received from the IPv4 communications apparatus a.co.jp to the IPv6 communications apparatus aaa.com (in a step S5 of FIG. 13).

Moreover, while communications are made from the IPv4 communications apparatus a.co.jp to the IPv6 communications apparatus aaa.com, even in a case where another communications request for an IPv6 communications apparatus “bbb.com” occurs from another IPv4 communications apparatus “b.co.jp”, or the like, the same temporary IPv4 address “4c” may be again used for the IPv4 communications apparatus b.co.jp directed to the IPv6 communications apparatus bbb.com, for example, and, then, by using it, relevant communicates can be made (in a steps S′1 through S′5 of FIG. 13). In this case, when the temporary IPv4 address is obtained, the use state of the temporary IPv4 address “4c” is already set as “4pa, 6a”, and newly requested communications on the transmission source port number “4pb” can be determined as not being coincident therewith as having the different port number, and as a result, the same temporary address 4c can be allocated again.

That is, by this method, since each temporary IPv4 address is registered combining a related transmission source port number, manytimes/multiple use of the same temporary IPv4 address is attained. Consequently, also by this method, effective use of temporary IPv4 addresses is attained. Thereby, it is possible to respond to the number of communications requests several times the number of the actual total available number of temporary addresses.

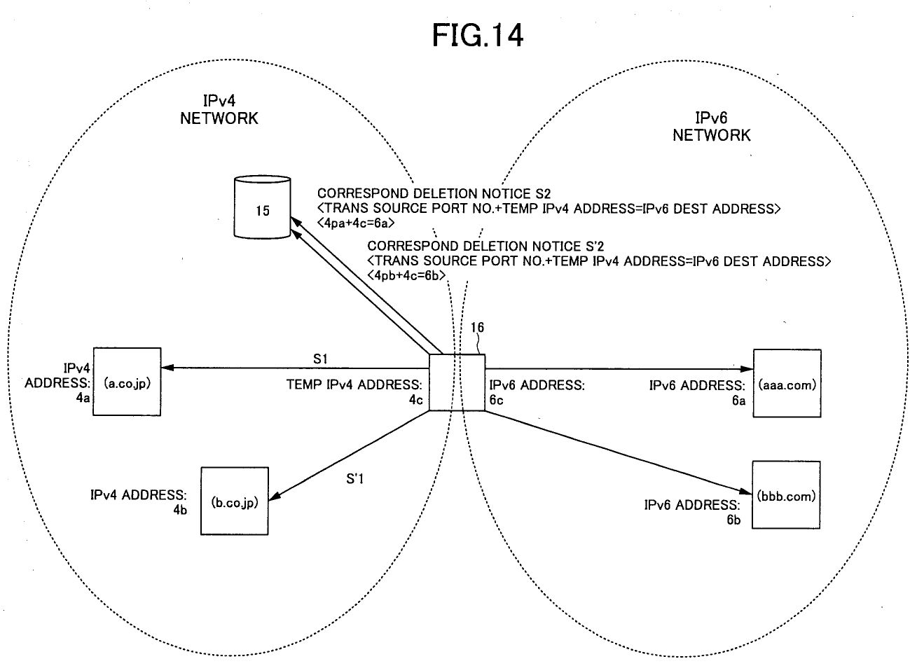

Next, how to delete correspondence information from the correspondence information table with the transmission source port number will now be described. FIG. 14 is a diagram illustrating a method of deleting from the correspondence information table with the transmission source port number. This method is a method of deleting correspondence information from the correspondence information table after the end of the communications directed to the an IPv6 communications apparatus started based on “the same correspondence information of the correspondence information table with the transmission source port number,”, thereby enabling reuse of the relevant temporary IPv4 address.

When communications are started from the IPv4 communications apparatus a.co.jp to the IPv6 communications apparatus aaa.com (in a step S1 of FIG. 14) with communications address conversion apparatus 16, the timer which monitors communications time, and the timer which monitors the interval of IP datagram are started. Whenever the timer which monitors the interval of IP datagram receives an IP datagram, it resets its measured value, and thus, it monitors the interval of the latest IP datagram. The actual operation and determination of the end of relevant communications are the same as those described above in the description of the first method. When the end of the communications is determined, the corresponding correspondence information is deleted from the correspondence information table with the transmission source port number.

A fact that a combination of a communications address (i.e., temporary address) assigned as an identifier indicating the communications apparatus at the other end together with an address of the transmission source communications apparatus or the application identifier (i.e., the transmission source port number in this case) is used for relevant communications is notified to the name solution apparatus from the communications address conversion apparatus 16. And also, a notice of the correspondence information deletion for deleting the correspondence information on the above-mentioned combination is sent to the name solution apparatus from the communications address conversion apparatus 16 after a predetermined time has elapsed, which time is determined beforehand, since the relevant communications were started (in a step S2 of FIG. 14). The name solution apparatus 15 to which the above-mentioned notice of correspondence information deletion is notified then deletes the corresponding correspondence information from the correspondence information table with the transmission source port number.

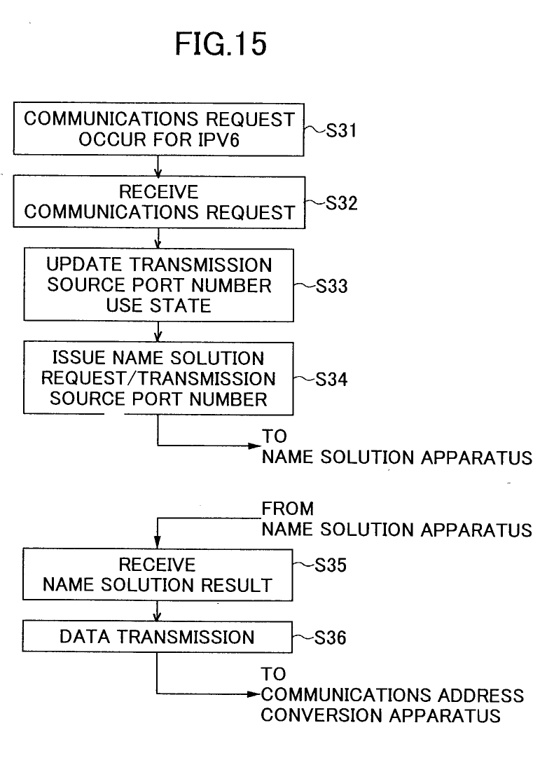

Next, processing of each apparatus in this second method will be described. Processing of each IPv4 communications apparatus will now be described first. FIG. 15 shows a processing flow chart of each IPv4 communications apparatus. When a communications request to the IPv6 communications apparatus aaa.com occurs from the IPv4 communications apparatus (in a step S31), a communications request concerned is received in the communications request reception part 22 (in a step S32). Then, from the transmission source port number table 24, a port number currently not used is extracted, and this transmission source port number is registered into the state under use (in a step S33). Next, a name solution request for the IPv6 communications apparatus to the name solution apparatus 15 and the notice of a transmission source port number are issued from the name solution inquiry part 23 to the data transmission/reception part 25 (in a step S34).

Then, after a reply to the name solution request is received from the name solution apparatus in the data transmission/reception part 25, a temporary IPv4 address is read therefrom in the name solution inquiry part 23 (in a step S35), and data transmission using the thus-obtained temporary IPv4 address is started from the communications request reception part 22 to the data transmission/reception part 25 (in a step S36).

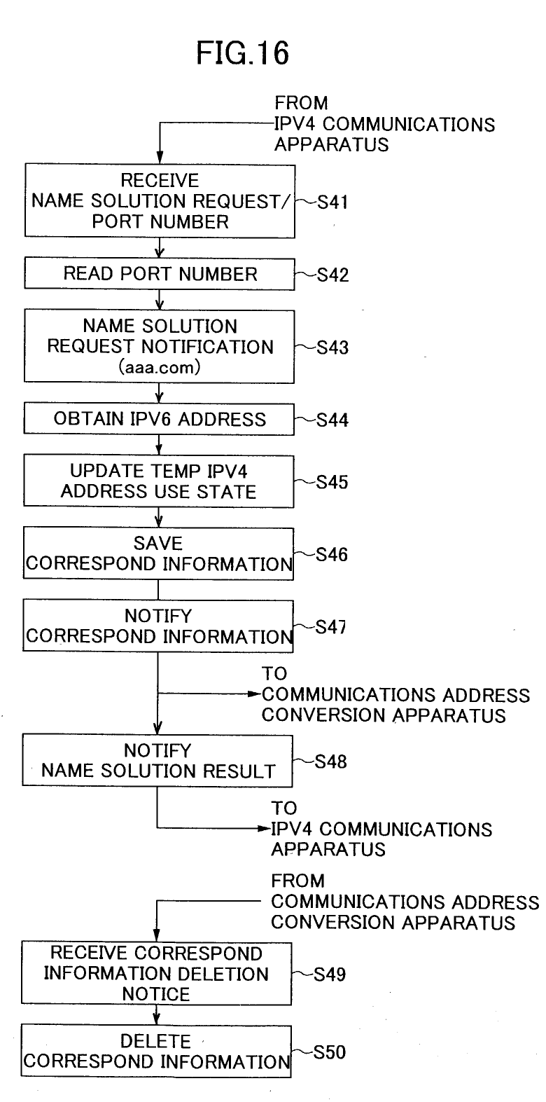

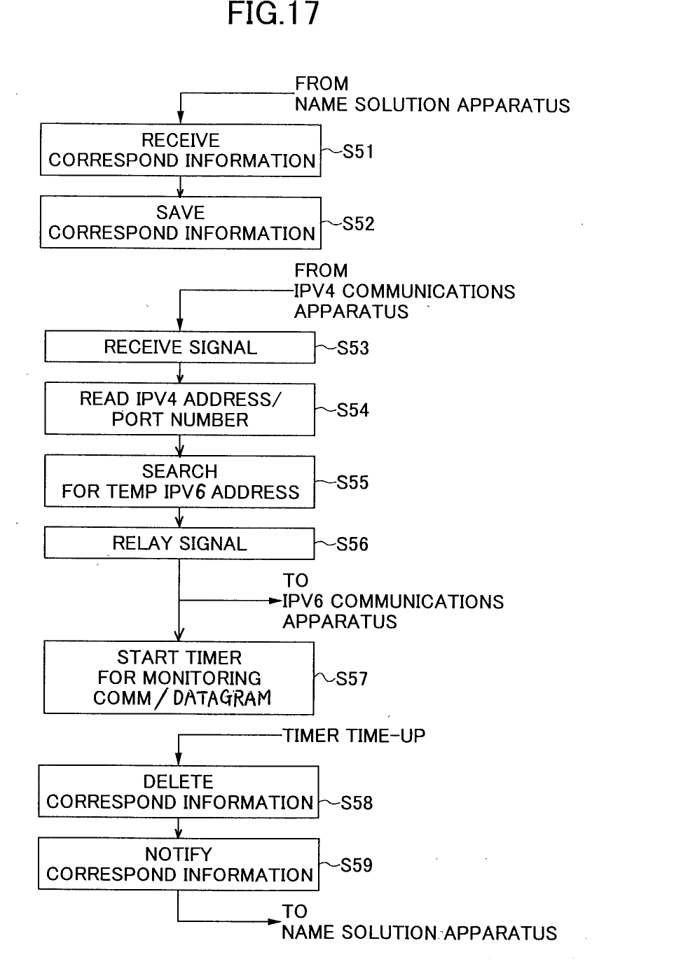

Next, processing of the name solution apparatus will now be described. FIG. 16 shows a processing flow chart of name solution apparatus. In the data transmission/reception part 36 of the name solution apparatus 15, when a name solution request and a notice of a transmission source port number are received from the IPv4 communications apparatus (in a step S41), the transmission source port number concerned is read therefrom (in a step S42), and the name solution request (aaa.com) from IPv4 communications apparatus is notified to the name solution part 31 (in a step S43). Then, the IPv6 address for the relevant IPv6 communications apparatus is obtained according to a predetermined name solution table in the name solution part 31 (in a step S44). Then, an address for which the use state of the temporary IPv4 address is not “4pa, 6a” is searched for from the temporary IPv4 address table 32. When, for example, the temporary IPv4 address “4c” is chosen as a result, setting is made as “4pa and 6a under use” for this temporary IPv4 address (in a step S45).

Next, into “the correspondence information table with the transmission source port number” among the correspondence information tables 33, the transmission source port number of the above-mentioned IPv4 communications apparatus, IPv6 address of IPv6 communications apparatus, and temporary IPv4 address are saved as correspondence information (in a step S46). The correspondence information notice part 34 makes a transmission request to the communications address conversion apparatus 16 with this correspondence information directed to the data transmission/reception part 36 (in a step S47). Next, in the name solution part 31, a transmission request is made to the data transmission/reception part 36 with the temporary IPv4 address as a reply to the name solution request from the IPv4 communications apparatus (in a step S48).

When a correspondence information deletion notice is received from the communications address conversion apparatus 16 in the data transmission/reception part 36 of the name solution apparatus 15 (in a step S49), this notice is transferred to the information deletion reception part 35. Then, the notified correspondence information is used as a key, the relevant correspondence information is acquired and deleted from the correspondence information table 33 (in a step S50).

Next, processing of the communications address conversion apparatus will now be described. FIG. 17 shows a processing flow chart of the communications address conversion apparatus. In the data transmission/reception part 47 of the communications address conversion apparatus 16, when correspondence information is received from the name solution apparatus 15 (in a step S51), the correspondence information concerned is read out by the correspondence information reception part 43, and, then, the contents thereof are saved into the correspondence information table 42 (in a step S52).

Next, in the data transmission/reception part 47 of the communications address conversion apparatus 16, when a signal for the temporary IPv4 address is received from the IPv4 communications apparatus (in a step S53), the temporary IPv4 address and transmission source port number (in a step S54) are read out therefrom, and the relevant IPv6 address is searched by the data relay part 41 from the correspondence information table 42 by using the temporary IPv4 address concerned and transmission source port number as a key (in a step S55).

Next, the signal received from the IPv4 communications apparatus is relayed by using the IPv6 address by the data relay part (in a step S56). At this time, the timer which monitors the communications time, and the timer which monitors the interval of IP datagram are started (in a step S57). And when the timer which monitors the communications time, or the timer which monitors the interval of IP datagram measures into the deadline, the correspondence information related to the communications monitored by the timer is deleted from the correspondence information table (in a step S58). Then, from the correspondence information deletion notice part 44, the correspondence information deletion notice is sent to the data transmission/reception part 47 for the name solution apparatus 15 (in a step S59).

The above-described first embodiment of the present invention has the following features: That is, according to the first method of the embodiment, an IPv6 address is identified from a combination of an IPv4 transmission source address and a temporary IPv4 address. For this reason, as long as IPv4 transmission source addresses differ, a same temporary IPv4 address can be used (multiple use) for identify a plurality of IPv6 communications apparatuses even in a case, simultaneously, a plurality of communications requests occur from a plurality of IPv4 communications apparatuses for a plurality of IPv6 communications apparatuses. Moreover, similarly, according to the second method, as an IPv6 address is identified from a combination of a relevant transmission source port number and an allocated temporary IPv4 address, as long as transmission source port numbers differ, the same temporary IPv4 address can be used many times at the same time.

In a case according to the second method, in which an IPv6 address is identified from a combination of a transmission source port number and a temporary IPv4 address, it is possible to deal with two types of cases, i.e., a first case in which communications requests occur to a plurality of IPv6 communications apparatuses from a plurality of IPv4 communications apparatuses; and a second case in which communications requests occur to a plurality of IPv6 communications apparatus from a single IPv4 communications apparatus.

Thus, since multiple use of same temporary IPv4 address can be simultaneously carried out according to the first embodiment of the present invention, the required total available number of temporary IPv4 addresses to be assigned to the communications address conversion apparatus 16 can be effectively reduced. As a result, it becomes possible to perform relay operation covering a large-scale communications between an IPv4 network and an IPv6 network with a reduced total available number of temporary IPv4 addresses needed at the same time.

Next, description will now be made for a further detailed apparatus configuration example of the above-described first embodiment of the present invention, and, also, for a case where the present invention is applied to a recording medium. The above-mentioned name solution apparatus 15 and communications address conversion apparatus 16 may be embodied by any type of computer, such as a workstation, a personal computer, or the like. In this case, the system includes a computer body, a display unit connected to the computer body, an input device (keyboard/mouse), a removable disk drive, a hard disk drive unit, etc.

A CPU which performs various internal control and internal processing, a ROM (non-volatile memory) for storing programs and various types of data, a work memory, an interface control part (I/F control part), a communications control part, etc. are provided in the computer body. A flexible disk drive, an optical disk drive, or the like may be used as the above-mentioned removable disk drive. In this computer system, the above-described various types of processing can be performed by storing a program for executing the processing of the name solution apparatus 15 and communications address conversion apparatus 16 in a magnetic disk (recording medium) of the hard disk drive unit, and reading this program and performing it by the CPU.

The program may be installed into the hard disk drive instead by the following method, and, after that, the program is executed by the CPU: That is, the program (which may be created by another computer system) stored in the removable disk is read by the removable disk drive, and is stored/installed into the recording medium of the hard disk drive unit. Alternatively, the program which may be transmitted from another computer system through a communications circuit, is received through the communications control part, and is stored/installed into the recording medium (magnetic disk) of the hard disk drive unit.

Next, problems which the above-described first embodiment of the present invention may involve will now be described. That is, according to the first embodiment of the present invention, the above-described respective processes may not be performed properly, in a case where name solution and actual communications may be performed by means of different communications interfaces where the plurality of communications interfaces are employed there, or in a case where an actual transmission source address of communications becomes different from a transmission source address on name solution where many name solution processes are performed for each communications occasion, or the like.

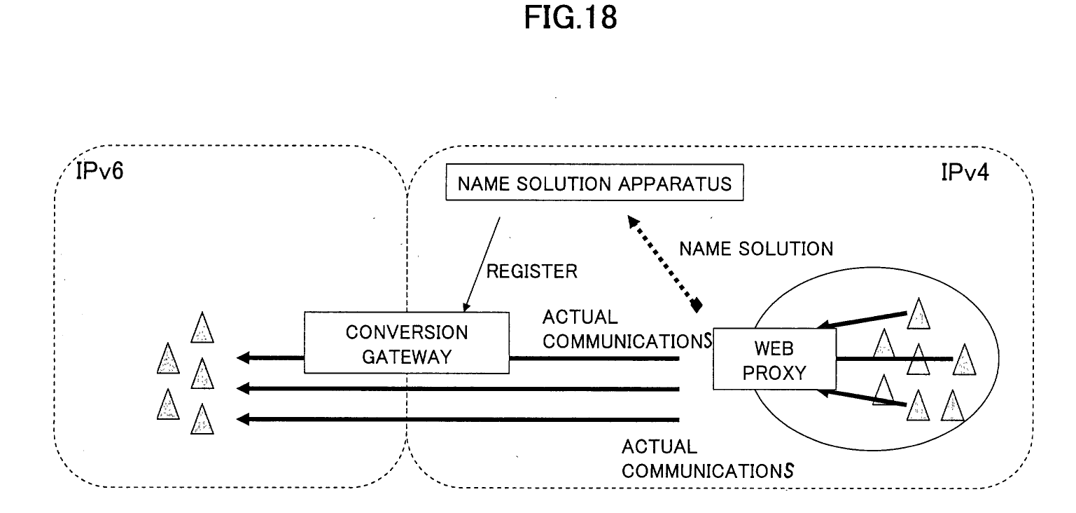

For example, a case of FIG. 18 will now be discussed, in which a communications apparatus which has an IPv4 address performs communications, via a substitute server, such as a web proxy server, with a communications apparatus of IPv6 . In this case, the IPv4 address of the transmission source related with an IPv4 temporary address may be changed into a substitute server's IPv4 address, and thus, may not become the own IPv4 address of the IPv4 communications apparatus which required the communications with the communications apparatus of the IPv6 network.

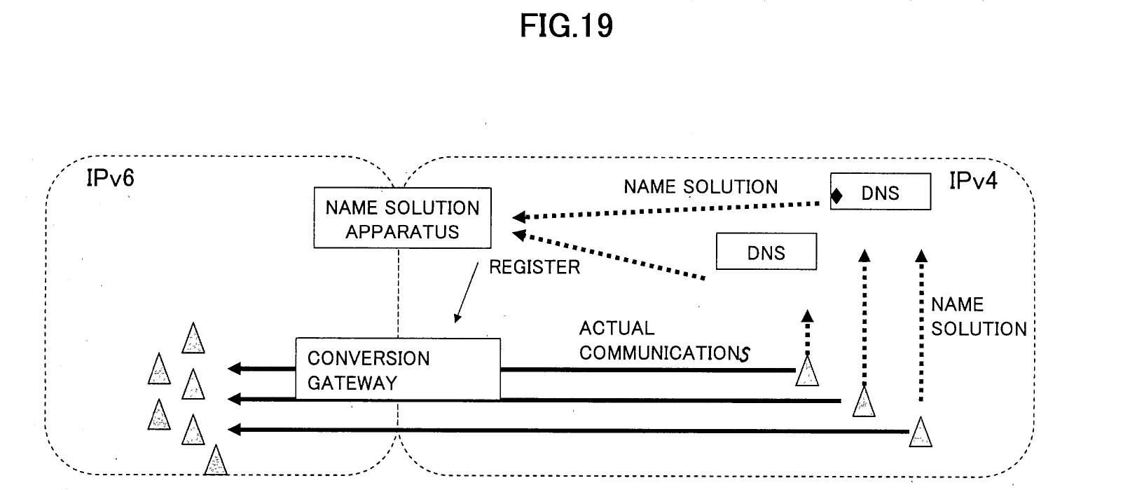

In another case, as shown in a FIG. 19, in case of multiple use of name solution apparatus, such as DNS, the IPv4 address of the transmission source related with an IPv4 temporary address may be changed into an IPv4 address of the name solution apparatus, and may not become the own IPv4 address of IPv4 communications apparatus which required the communications with the communications apparatus of the IPv6 network.

A second embodiment of the present invention has been devised for the purpose of solving such a problem. According to the second embodiment of the present invention, inconsistency in transmission source address is prevented from occurring between on name solution and on actual communications occasion by performing registration of transmission source address, not at a time of name solution but at a time an actual communications occur.

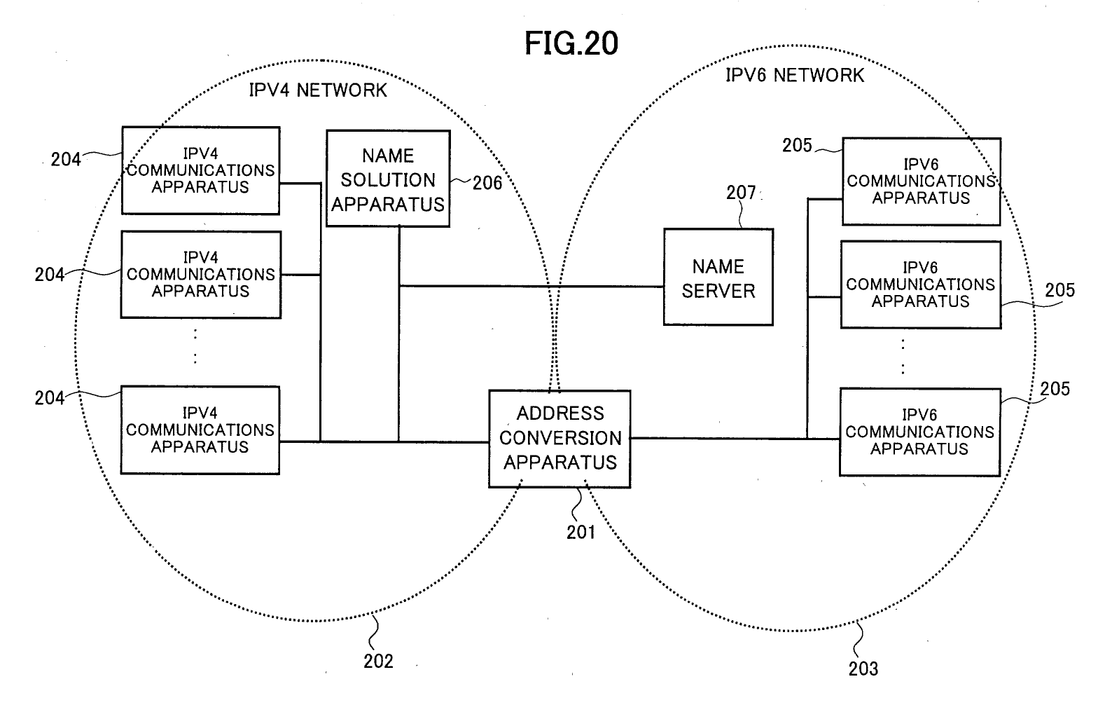

FIG. 20 shows a configuration of the second embodiment of the present invention. A communications system according to the second embodiment includes: communications apparatuses 204 on IPv4 network 202 (simply referred to as IPv4 communications apparatuses, hereinafter), communications apparatuses 205 on Pv6 network 203 (simply referred to as IPv6 communications apparatuses, hereinafter), a name solution apparatus 206 which changes a given name of IPv6 communications apparatus 205 into a relevant communications address, an address conversion apparatus 201 which relays communications between the IPv4 network and the IPv6 network, and a name server 207 which stores correspondence information indicating correspondence between each communications apparatus and corresponding IP address, and changes a given name into a corresponding IP address.

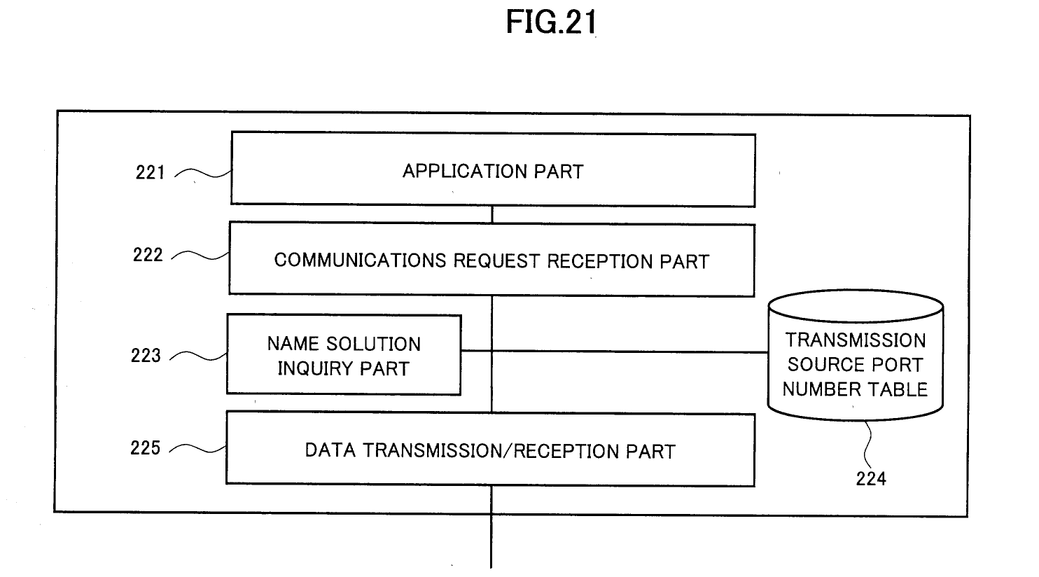

FIG. 21 shows a configuration of each IPv4 communications apparatus 204. As shown in the figure, the IPv4 communications apparatus 204 includes: an application part 221 which makes a communications request, a communications request reception part 222 which receives the communication request for an IPv6 communications apparatus 205 sent from the application part, a name solution inquiry part 223 which asks the name solution apparatus 206 a destination address in IPv4 address based on a given host name of the IPv6 communication apparatus 205, and a transmission source port number table 224 managing transmission port numbers used in communications occasions, and a data transmission/reception part 225.

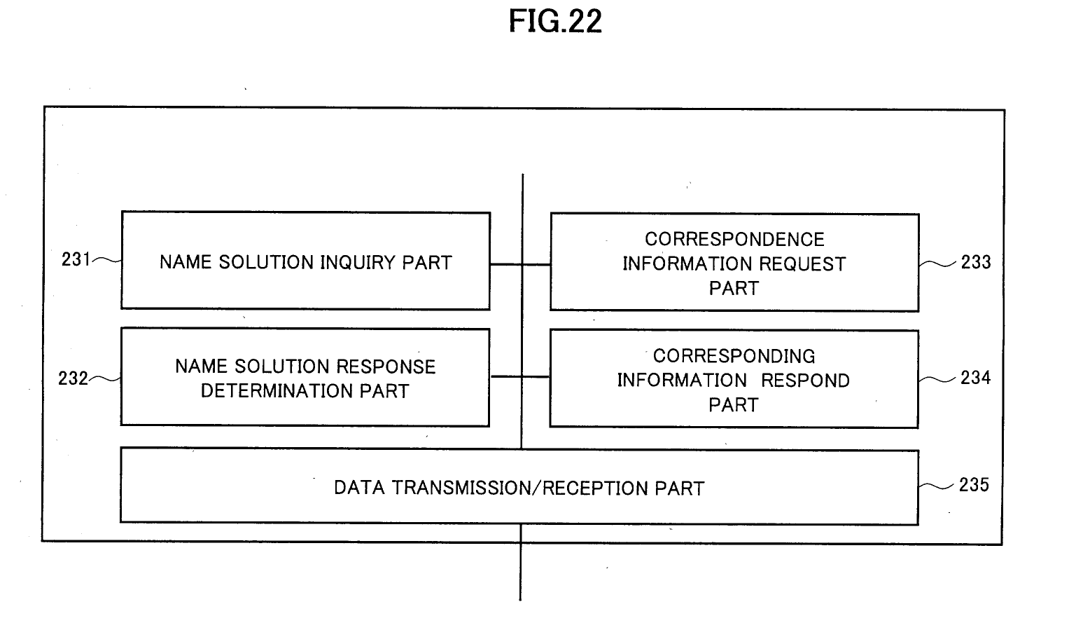

FIG. 22 shows a configuration diagram of the name solution apparatus 206. The name solution apparatus 206 includes a name inquiry part 231 which inquires of the name server 207 with a given host name, a determination part 232 which determines, from a result of the above-mentioned inquiry, whether or not it is necessary to make a correspondence for the address for another address system, a correspondence inquiry part 233 which inquires a correspondence in case the correspondence is needed, a correspondence information response part 234 which responds to the communications apparatus which required the name solution concerned with the correspondence result, and a data transmission/reception-part 235.

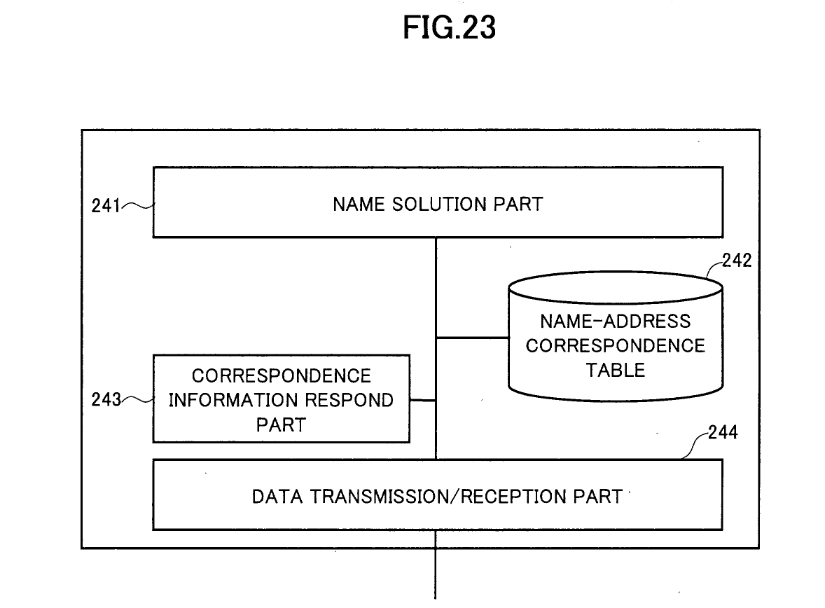

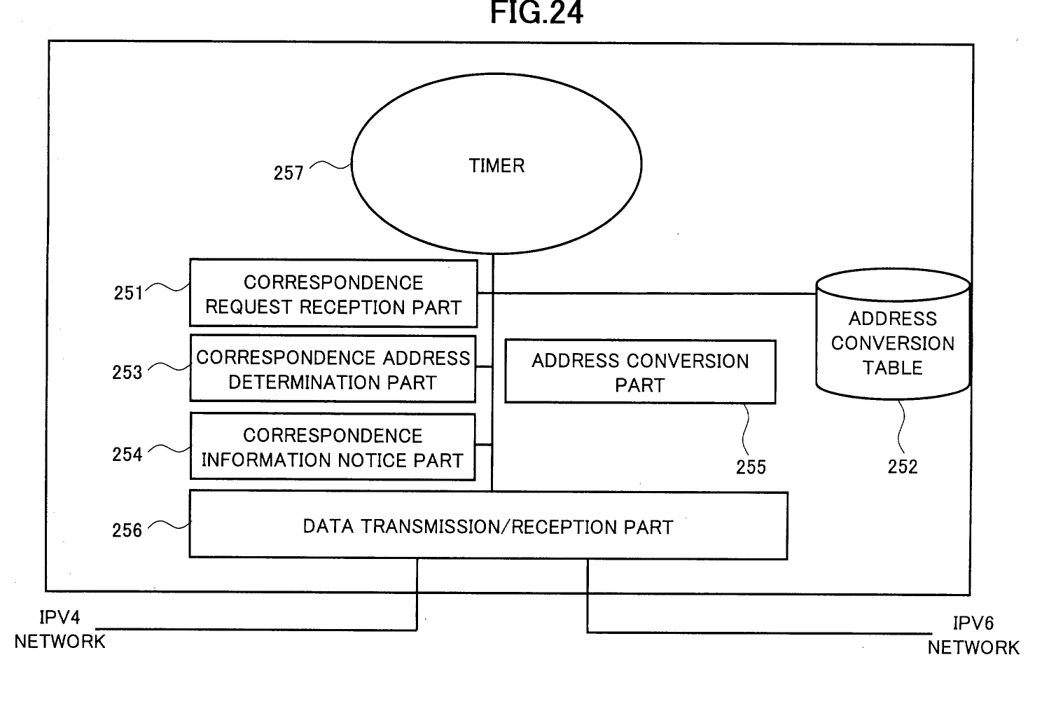

FIG. 23 shows a configuration diagram of the name server 207. The name server 207, which receives a name solution request, includes a name-address correspondence table 242 holding a correspondence between a given name and an address thereof, a name solution part 241 which searches for an address assigned from a given name using the name-address correspondence table 242 so as to solves the name, a correspondence information response part 243 which responds a name solution request source with a solution result, and a data transmission/reception part 244.

FIG. 24 shows a configuration diagram of the address conversion apparatus 201. The address conversion apparatus 201 includes: a correspondence request reception part 251 which receives a correspondence request for a temporary IPv4 address sent from the name solution apparatus 206, a correspondence address determination part 253 which assigns a temporary IPv4 address by searching an address conversion table 252 in response to a request, a correspondence information notice part 254 which responds the name solution apparatus 206 with a correspondence result, an address conversion part 255 which receives actual communications, and appropriately converts a given address by searching the address conversion table 252, a data communications part 256 and a timer 257 which measures an existence time for every entry of “temporary allocated” state remaining on the address conversion table 252.

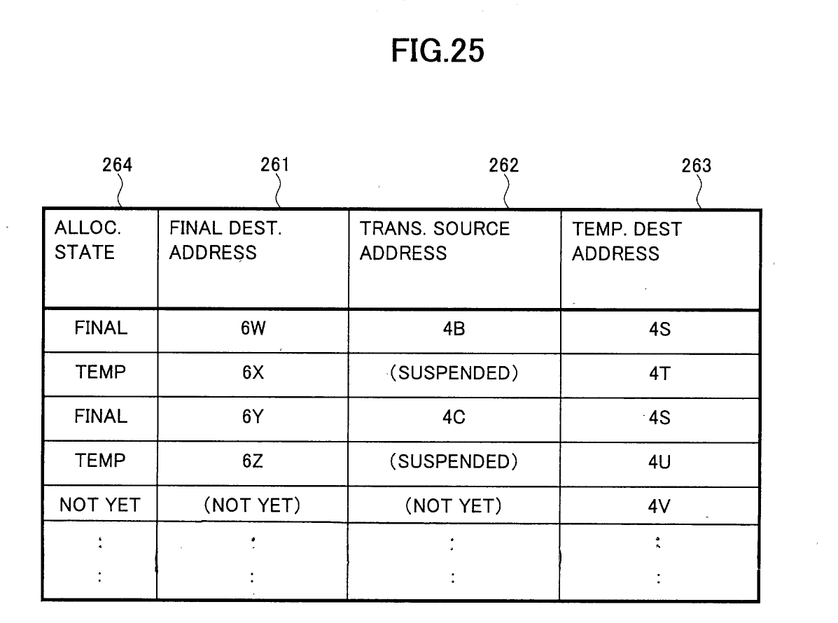

FIG. 25 shows an example of the contents of the address conversion table 252 which the address conversion apparatus 201 holds. The address conversion table 252 includes a plurality of entries each having the following items, i.e., a final destination address 261 which shows a final TP address of a different address management system from that of a source communications apparatus concerned, a transmission source address 262 which shows a transmission source IP address of the communications apparatus, a temporary destination address 263 used for identifying the address of a communications destination of the address management system different from that of the communications apparatus of the transmission source, and an allocation state 264 which shows an allocation state of the entry.

The number of the respective entries of the address conversion table 252 is at least the total available IPv4 addresses which can be allocated temporarily for the IPv6 network 203 from the IPv4 network. Further, at least one entry is provided for each IPv4 address which is temporarily allocated, and, an IPv4 address is beforehand set in the temporary destination address 263 thereof. When the allocation state 264 is of finally allocated, the temporary address 263 specified by the transmission source of the transmission source address 262 is converted into the final destination address 261.

A plurality of entries can be set for a same temporary destination address 263 on which the allocation state 264 is of finally allocated, having the transmission source addresses 262 and the final destination addresses 261 each different from one another. Although the temporary destination address 263 is finally allocated to the final destination address 261, the transmission source address 262 is in a “suspension” state while the allocation state 264 is of “temporary allocated”.

At a stage at which the communications apparatus indicates this temporary destination address 263 so as to start actual communications, the address conversion apparatus 201 which receives it registers the transmission source IP address of this communications apparatus as the transmission source address 262 of the relevant “temporary allocated” entry, and, then, changes the allocation state thereof from of “temporary allocated” into of “finally allocated”. However, not a plurality of entries can exist whose allocation state 264 is of “temporary allocated“, having the same temporary destination address 263. Thereby, when a communications apparatus indicates this temporary destination address 263 and starts actual communications, the final destination address 261 can be prevented from being obtained through erroneous conversion from the temporary destination address 263.

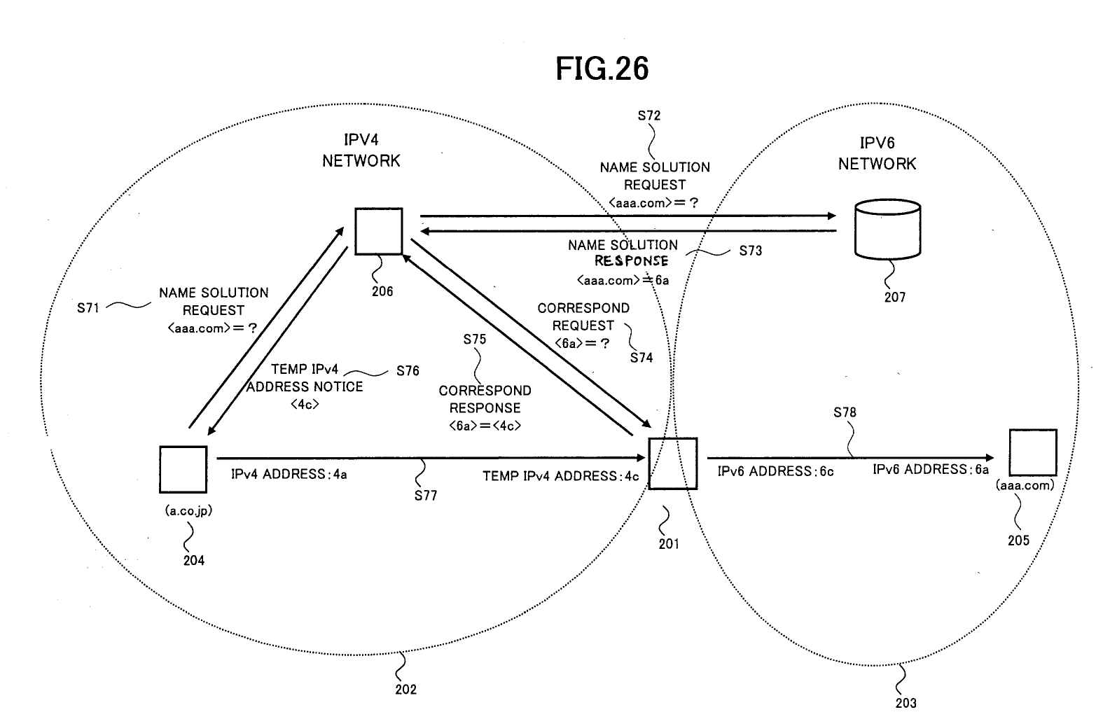

FIG. 26 shows how the address conversion apparatus 201 registers a transmission source address when an IPv4 communications apparatus 204 starts actual communications according to the second embodiment of the present invention. For example, when communicating from an IPv4 communications apparatus 204 “a.co.jp” to an IPv6 communications apparatus 205 “aaa.com”, the IPv4 communications apparatus 204 (a.co.jp) asks as a name solution request to the name solution apparatus 206 for an IPv4 address of “aaa.com” which is the name of the IPv6 communications apparatus 205 (aaa.com) (in a step S71). The name solution apparatus 206 which received the name solution request concerned from the IPv4 communications apparatus 204 (a.co.jp) asks as a name solution request of the name servers 207 which may hold relevant address information for “aaa.com” (in a step S72).

In the name server 207 which received the name solution request concerned, the name solution part 241 searches the name-address correspondence table 242, obtains the IPv6 address “6a” corresponding to “aaa.com”, and, therewith, the name solution response part 243 answers the name solution apparatus 206 (in a step S73). The name solution apparatus 206 which received the name solution response concerned determines whether or not it is necessary to require a correspondence for an address of the address conversion apparatus 201 in the name solution response determination part 232.

When it is determined that it is necessary to require as a result, the correspondence information request part 233 requires a correspondence for a temporary IPv4 address with respect to the above-mentioned “6a” of the address conversion apparatus 201 (in a step S74). The address conversion apparatus 201 which received the correspondence request on the address concerned receives this in the correspondence address request reception part 251, and then the correspondence address determination part 253 determines an IPv4 address of “4c” for “6a” by searching the address conversion table 252. And the result is responded by the correspondence information response part 54 to the name solution apparatus 106 (in a step S75).

The correspondence information response part 234 answers the temporary IPv4 address “4c” which received the address correspondence response concerned from the address conversion apparatus 201, to the IPv4 communications apparatus 204 (in a step S76). The IPv4 communications apparatus 204 which received the result on the name solution concerned transmits an IPv4 packet directed to the thus-obtained temporary IPv4“4c” (in a step S77).

Predetermined path control is carried out such that the IPv4 packet directed to the this temporary IPv4“4c” reaches the address conversion apparatus 201, and the data receiving part 256 of the address conversion apparatus 201 receives the packet for this “4c”. The address conversion part 255 of the address conversion apparatus 201 determines that this IPv4 packet for “4c” should be processed with address conversion, and thus obtains a relevant IPv6 address by searching the address conversion table 252. And the IP address of the received packet is changed into “6a”, and is sent out (in a step S78).

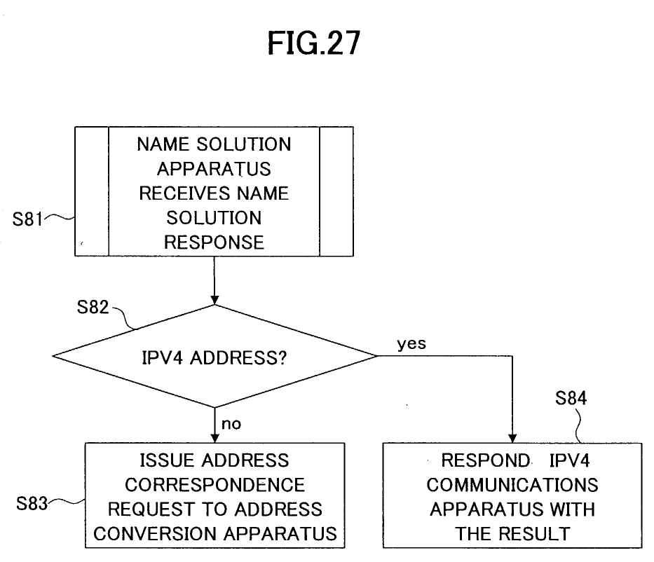

Operation in the above-mentioned name solution apparatus 206 and address conversion apparatus 201 will now be described based on a flow chart. FIG. 27 is a flow chart which shows operation at a time of name solution apparatus 206 receives a name solution response from the name server 207. In this figure, when the name solution apparatus 206 receives the name solution response in a step S71 from the name server 207 (in a step S81), the result of name solution is checked as to whether it is an IPv4 address or an IPv6 address. Since the “IPv4 ” communications apparatus 204 makes the name solution request, it is determined in this case as to whether or not the relevant address is an IPv4 address (in a step S82).

When the result is an IPv6 address, in a step S73 which is the communications which requires correspondence for a temporary IPv4 address with respect to the IPv6 address to the address conversion apparatus 201 is performed (in a step S83). However, in a case where the check result is an IPv4 address, the IPv4 address is answered to the IPv4 communications apparatus 204 which performed the name solution request (in a step S84).

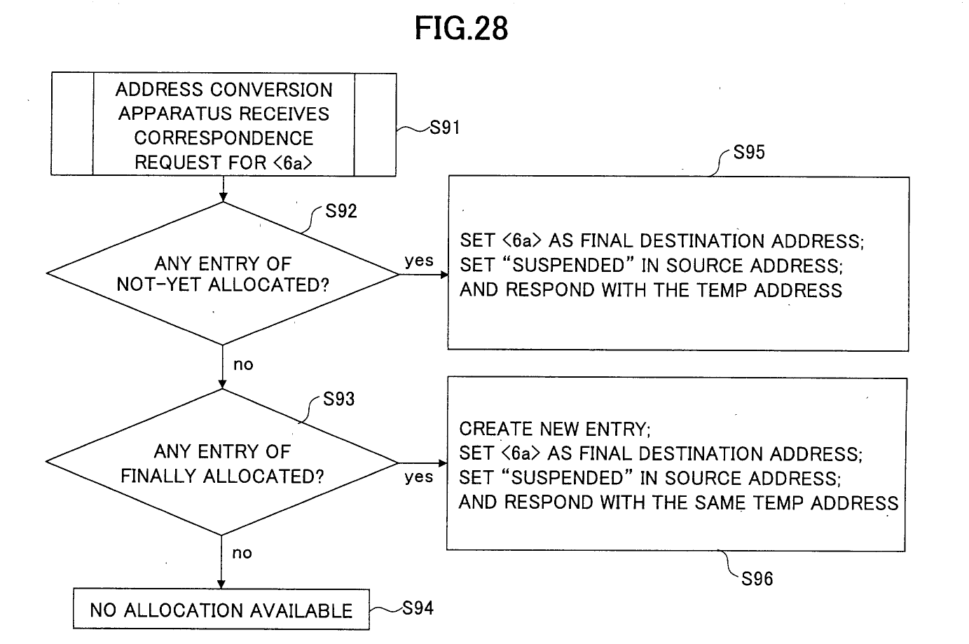

FIG. 28 is a flow chart which shows operation at a time of the address conversion apparatus 201 receiving an address correspondence request. It is assumed that, for example, a temporary destination IPv4 address is allocated with a correspondence to an IPv6 address <6a>. When the address conversion apparatus 201 receives an address correspondence request in a step S74 from the name solution apparatus 206 (in a step S91), it searches as to whether or not an entry having the allocation state 264 of “not-yet allocated” exits in the address conversion table 252 (in a step S92).

When there is a not-yet-allocated entry as a result, <6a> is then registered into the final destination address 261 of this entry, the allocation state 264 thereof is set up as “temporary allocated”, and the transmission source address 262 thereof is set into a “suspension” state. And, as a response of address correspondence, the temporary allocation address 263 of the entry is sent out as in the step S75 to the name solution apparatus 206 (in a step S95).

On the other hand, when there is no not-yet-allocated entry as a result of the search in the above-mentioned step S92, search is made as to whether or not there is any entry of “finally allocated” in the allocation state 264 in the address conversion table 252 at this time (in a step S93),. When there is an entry of finally allocated, a new entry with the same temporary destination address 263 is created having the same temporary destination address as that of the above-mentioned finally allocated entry, and is added to the address conversion table 252. And, <6a> is registered into the final destination address 261 of this newly added entry, the allocation state 264 thereof is set as “temporary allocated”, and the transmission source address 262 is made into a “suspension” state. And, as a response of address correspondence, the temporary destination address 263 of the entry is sent out via the communications of the step S75 to the name solution apparatus 206 (in a step S96).

When the allocation state 264 of all the entries of the address conversion table 252 is in a “temporary allocated” state as a result of search of the above-mentioned steps S92 and S93, as this means that there is no temporary destination address 263 which can be allocated temporarily to the present address correspondence request, this address correspondence request is canceled (in a step S94).

The processing order of the step S92 and the step S93 may be replaced with one another.

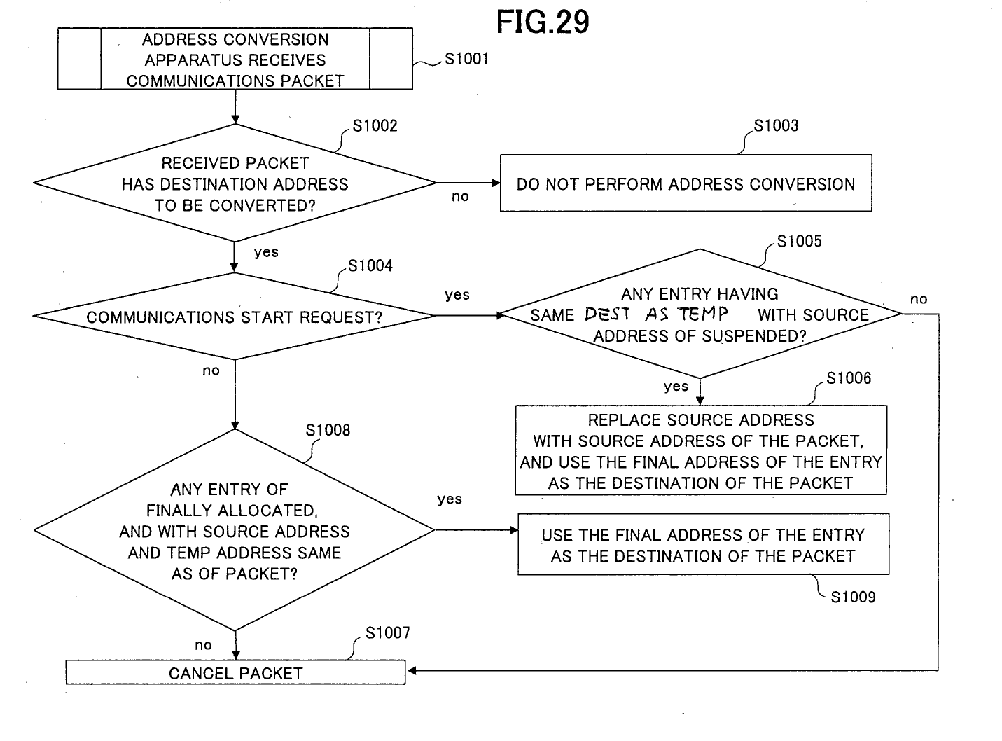

FIG. 29 is a flow chart which shows operation at a time of the address conversion apparatus 201 receiving a communications packet which an IPv4 communications apparatus 204 transmits. When the address conversion apparatus 201 receives the communications packet via the step S77 which the IPv4 communications apparatus 204 transmits (in a step S1001), the address conversion apparatus 201 determines whether or not the communications packet should be processed with address conversion (in a step S102).

This determination is performed by checking whether or not this packet is directed to an address corresponding to that predetermined for being processed with address conversion, for example. When the packet concerned is a communications packet which is not one to be processed with address conversion as a result of this determination, the address conversion apparatus 201 performs nothing on the communications packet (in a step S1003).

When this is a packet to be processed with address conversion, it is then checked as to whether or not the packet includes a communications start request (in a step S1004). The method of distinguishing whether or not the relevant packet includes the communications start request may be such as that of checking as to whether or not it includes a predetermined specific communications start command, or by checking as to whether or not the port number which the communications packet concerned has corresponds to one which is a specific one predetermined as being used for communications starting, or the like.

When the received packet includes a start request as a result of the above-mentioned determination, search is made on the address conversion table 252 as to whether there is any entry whose allocation state 264 is of temporary allocated, and whose temporary destination address 263 is coincident with the transmission destination address of the communications packet (in a step S1005). When there is a relevant entry in the address conversion table 252 as a result of search, the transmission source address of the communications packet concerned is set into the transmission source address 262 of the entry, and the allocation state thereof is made into of finally allocated (in a step S1006). Consequently, the communications packet which indicates the temporary destination address 263 of this entry with the same transmission source after that comes to be converted into the communications packet to be sent to the final destination address 261 of the same entry.

When there is no relevant entry in the address conversion table 252 as a result of the above-mentioned search, the communications packet concerned is canceled (in a step S1007). On the other hand, when the received packet is not one including a start request, search is made as to whether or not there is an entry whose allocation state 264 is of finally allocated, whose temporary destination address is coincident with the transmission destination address of the communications packet concerned, and also, whose transmission source address 262 is coincident with the transmission source address of the communications packet concerned (in a step S1008).

When there is a relevant entry in the address conversion table 252 as a result of the search, this communications packet is converted into a communications packet to be sent to the final destination address 261 of the same entry as in the above-mentioned case (in a step S1009). When there is no relevant entry in the address conversion table 252 as a result of the search, this communications packet is canceled (in a step S1007).

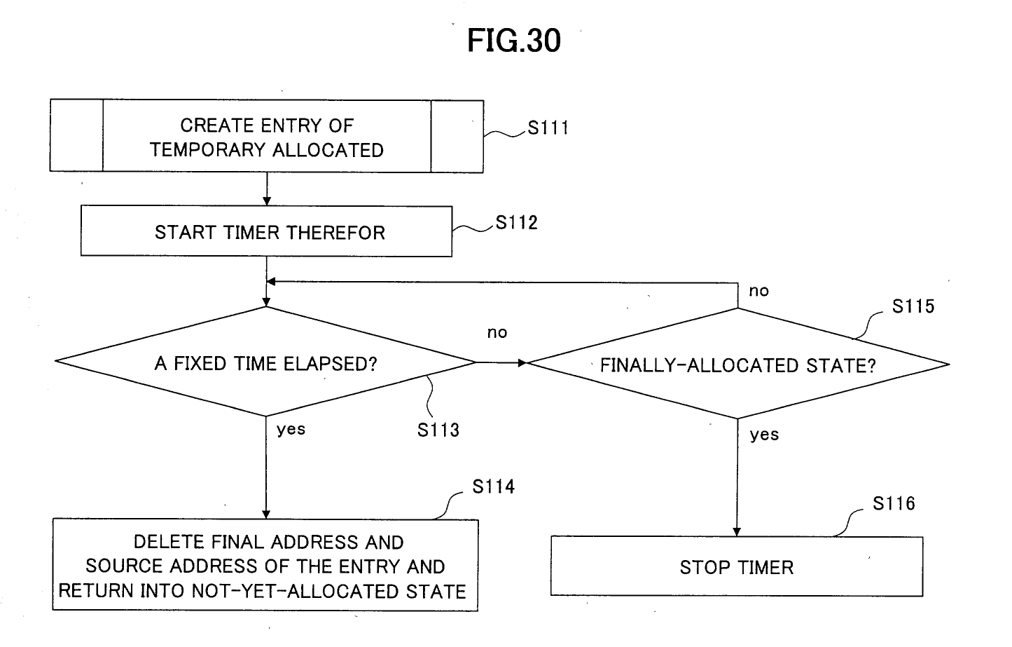

FIG. 30 shows operation for deleting an entry left in the address conversion table 252 with the state of temporary allocated. Each time an entry of a temporary allocated state in the allocation state 264 is created in the address conversion table 252 (in a step S111), the timer 257 which can measure for each entry is made to start measurement (in a step S112). And it is determined as to whether the measurement value of the timer 257 exceeds a predetermined value (in a step S113), and, when it exceeds, the entry is retuned into the state of not-yet allocated (in a step S114). When it have not exceeded, it is then determined as to whether or not the allocation state 264 of the same entry is changed into of finally allocated. Then, when it is changed into of finally allocated, the timer measurement on this entry is stopped.

Furthermore, when a predetermined interval has elapsed after it is finally used or a communications end thereof could be determined by a predetermined communications command on the communications packet even when the allocation state 264 thereof is of finally allocated, the relevant entry may be returned into a not-yet-allocated state.

Thus, according to the above-described second embodiment of the present invention, at a stage of processing a communications request, only a relevant IPv6 destination address is registered while the transmission source address item is left as “suspension” for a relevant temporary IPv4 address. And then, when actual relevant communications are started, the transmission source address of the packet sent from the transmission source IPv4 communications apparatus is registered as the transmission source address item corresponding to the temporary IPv4 address. Consequently, always the correct transmission source address is registered to the temporary IPv4 address concerned.

However, also according to the above-described second embodiment of the present invention, proper communications may not be performed when the same IPv4 communications apparatus 204 performs communications with a plurality of different IPv6 communications apparatuses 205 simultaneously, and, also, at that time, the same temporary address is allocated therefor accidentally. When the IPv4 communications apparatus 204 is a communications apparatus which does not communicate with a plurality of IPv6 communications apparatuses 205 simultaneously like a cellular phone, such a problem does not arise. Moreover, even when the same IPv4 communications apparatus 204 communicates with a plurality of IPv6 communications apparatuses 205 simultaneously, a possibility that the same temporary address is allocated therefor accidentally is very low.

A third embodiment of the present invention provides a configuration by which proper communications can be performed even when such a rare state occurs.

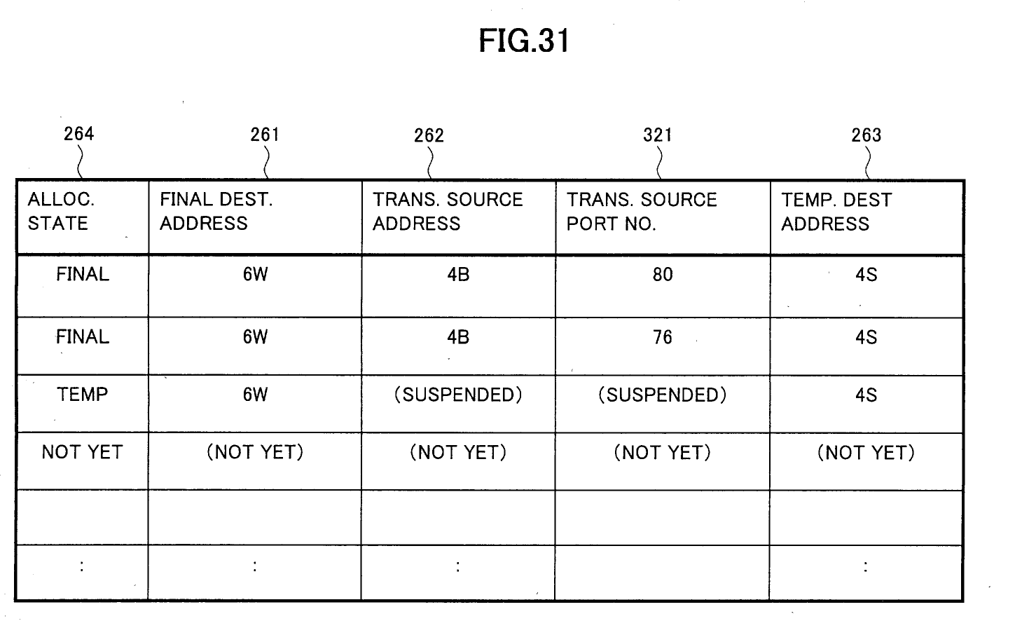

FIG. 31 shows an address conversion table 252 which an address conversion apparatus 201 according to the third embodiment of the present invention holds. On the address conversion table 252 in this embodiment, an item of transmission source port number 121 as an application identifier by which a plurality of occasions of communications can be identified on a same IPv4 communications apparatus 204 is added to each entry.

And, when a communications packet is received while an entry has the allocation state 264 of finally allocated, the transmission source address of the communications packet is coincident with the same item 262 of the entry, the transmission source port number currently used in the IPv4 communications apparatus 204 which has the transmission source address 262 same as that of the entry is coincident with the same item 321 of the entry, and also, the temporary address indicated by the communications packet is coincident with the same item 263 of the entry, the address of the communications packet is changed into the final destination address 261 of the entry.

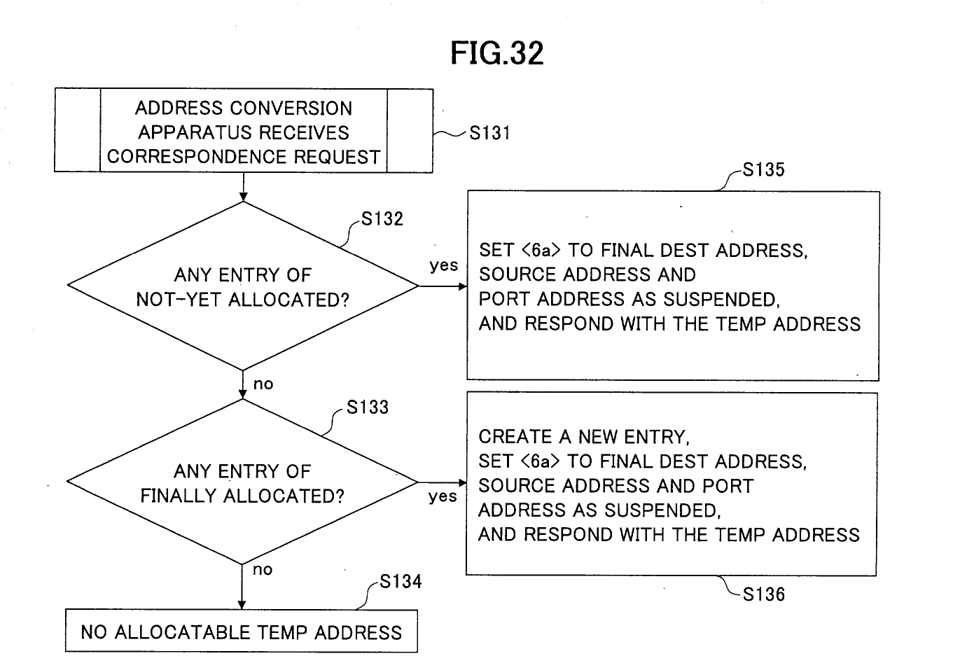

FIG. 32 is a flow chart which shows operation at a time of the address conversion apparatus 201 according to the third embodiment receiving an address correspondence request. It is assumed that, for example, a temporary destination IPv4 address is allocated for an IPv6 address <6a>.

When the address conversion apparatus 201 receives an address correspondence request via the step S74 from the name solution apparatus 206 (in a step S131), search is made as to whether or not an entry having the allocation state 264 of not-yet allocated exists in the address conversion table 252 (in a step S132).

When there is a not-yet-allocated entry, <6a> is registered as the final destination address 261 of this entry, the allocation state 264 thereof is changed into “of temporary allocated”, and the transmission source address 262 and the transmission source port number 321 are set as a “suspension” state each. And, as a response of address correspondence, the temporary allocation address 263 of the entry is sent via communications of the step S75 to the name solution apparatus 206 (in a step S135).

When there is no not-yet-allocated entry in the address conversion table 252 as a result of the above-mentioned search, then search is made as to whether or not an entry of finically allocated state in the allocation state 264 in the address conversion table 252 (in a step S133). When there is an entry of finally allocated state, a new entry with the same temporary destination address 263 as that of the above-mentioned entry of finally allocated state is created, and the new entry is added to the address conversion table 252. And, <6a> is registered into the final destination address 261 of this new entry, the allocation state 264 thereof is set as “of temporary allocated”, and the transmission source address 262 and the transmission source port number 321 are set into a “suspension” state each. And, as a response of address correspondence, the temporary allocation address 263 of the entry is transmitted to the name solution apparatus 206 via the communications of step S75 (in a step S136).

When the allocation state 264 of all the entries of the address conversion table 252 is in a temporary allocated state as a result of the above-mentioned search, as this means that there is no temporary destination address 263 which can be allocated temporarily to the present address correspondence request, this address correspondence request is cancelled (in a step S134).

The processing order of the step S132 and step S133 may be replaced.

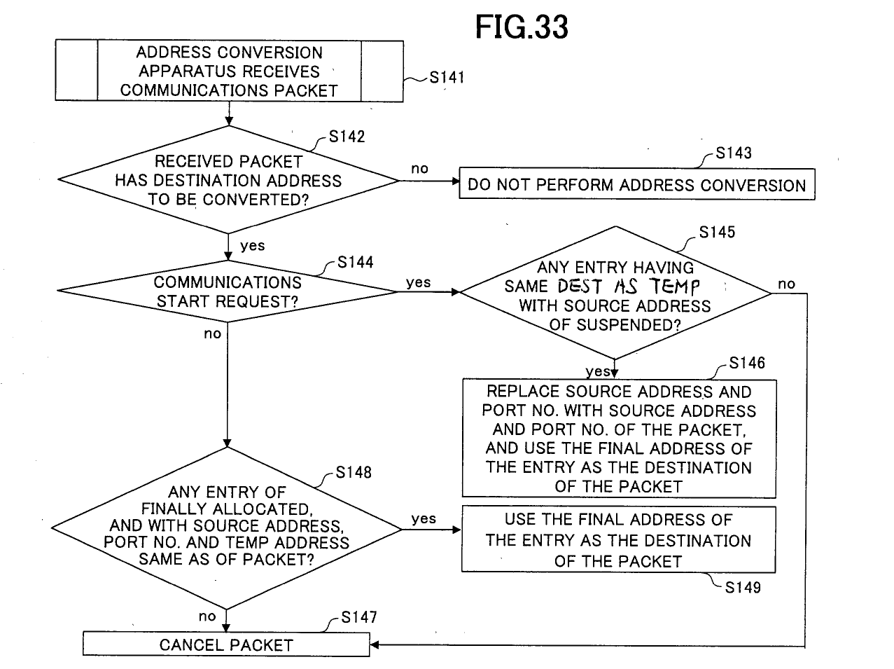

FIG. 33 is a flow chart which shows operation at a time of reception of a communications packet by the address conversion apparatus 201 transmitted from an IPv4 communications apparatus 204 according to the third embodiment of the present invention. Tn this figure, when the address conversion apparatus 201 receives the communications packet via the step S77 which the IPv4 communications apparatus 204 transmits (in a step S141), the address conversion apparatus 201 determines whether or not the communications packet is to be processed with address conversion (in a step S142). This determination can be made by checking as to whether or not this packet is directed to an address corresponding to one predetermined to be processed with address conversion, or the like.

When it is determined that the communications packet is not one to be processed with address conversion as a result, the address conversion apparatus 201 performs nothing on the communications packet (in a step S143). When this packet is determined as a packet to be processed with address conversion, the packet is determined as to whether or not it has a communications start request (in a step S144). This determination can be made by checking as to whether or not it has a specific communications start command, as to whether or not it has a port number corresponding to one which is specifically used in communications start occasion, or the like.

When the received packet is determined to have a start request as a result, search is made as to whether there is an entry of “temporary allocated” state in the item 264, wherein the temporary destination address 263 of the entry is coincident with the transmission destination address of the communications packet, in the address conversion table 252 (in a step S145). When there is a relevant entry in the address conversion table 252 as a result of the search, the transmission source address of the communications packet concerned is registered into the transmission source address item 262 of this entry, the transmission source port number of the communications packet concerned is registered into the transmission source port number item 321 of the same entry, and the allocation state item 264 is changed into “finally allocated” (in a step S146).

Consequently, each communications packet which specifies the temporary destination address 263 of this entry by a same operation program which operates on the same IPv4 communications apparatus 204 henceforth comes to be changed into a communications packet directed to the final destination address 261 of the same entry.

On the other hand, when there is no relevant entry in the address conversion table 252 as a result of the above-mentioned search, this communications packet is canceled (in a step S147). Moreover, when the received packet is not one of a start request, search is made as to whether or not an entry having the allocation state item 264 of “finally allocated”, the temporary destination address 263 same as the transmission destination address of the communications packet concerned, the transmission source address 262 same as that of this packet, and, also, the transmission source port number 321 same as that of the communications packet concerned is included in the address conversion table 252 (in a step S148).

When there is a relevant entry in the address conversion table 252 as a result of the search, address conversion of this communications packet is carried out into the communications packet directed to the final destination address 261 of the same entry (in a step S149).

When there is no relevant entry in the address conversion table 252 as a result of the search, this communications packet is canceled (in a step S147).

Thus, according to the third embodiment of the present invention, even in a case where a plurality of communications occasions are simultaneously occur from an IPv4 communications apparatus which has the same transmission source address, a same temporary IPv4 address can be allocated therefor. That is, since these plurality of occasions of communications have different transmission source port numbers allocated although they are made from the single IPv4 communications apparatus of the same transmission source address, by registering these transmission source port numbers together with the temporary IPv4 address concerned collectively, for the respective occasions of communications, these can be positively distinguished correctly and thus communications can be properly performed with the respective IPv6 destination communications apparatuses.

Although not shown in the figure, the above-mentioned address conversion apparatus may be embodied as a hardware by a computer which includes a bus which connects one or a plurality of CPUs, a main memory unit, an external storage, such as a hard disk drive, and a communications device, and so forth. A software program for operating this computer as the address conversion apparatus may be stored in a recording medium such as a carriable medium memory, a semiconductor memory, a hard disk drive, etc., the program being appropriately executed by the CPU(s)

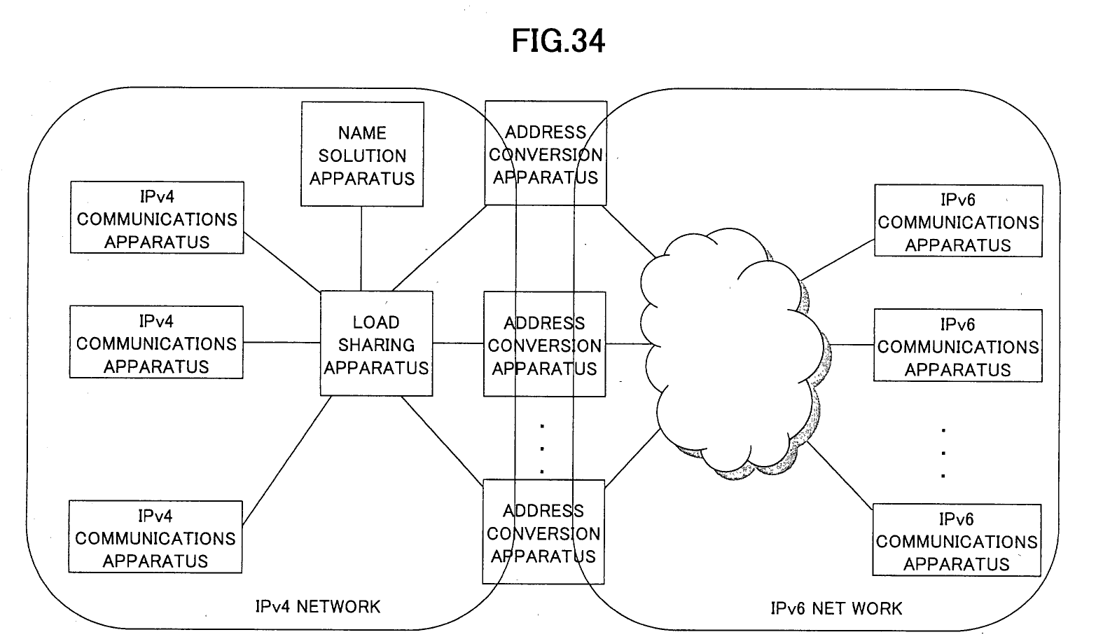

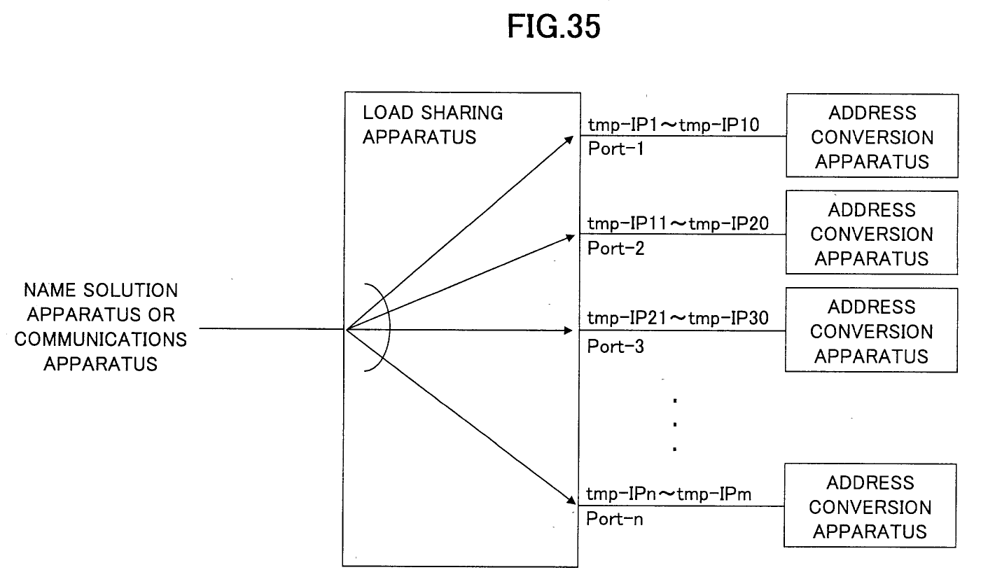

A method of load sharing with regard to the processing load borne by the address conversion apparatus according to each of the above-mentioned embodiments of the present invention into a plurality of address conversion apparatuses will now be described. According to each embodiment described above, after a correspondence request signal or correspondence notice signal is sent from the name solution apparatus, a communications signal is sent from a relevant communications terminal. In order to perform load sharing with regard to communications including such two sets of bidirectional communications with different apparatuses, first, the correspondence request signals or the correspondence notice signals from the name solution apparatus are distributed by means of a predetermined load sharing apparatus. Thereby, the signals are made to be sent to respective particular address conversion apparatuses. Then, communications signals directed to temporary addresses to be handled by the respective address conversion apparatuses are made to be sent to the relevant address conversion apparatus, respectively (see FIGS. 34 and 35).

In such a case, when the signal transmitted from the name solution apparatus is a correspondence request signal or notice signal, the load sharing apparatus should transfer this signal to a specific address conversion apparatus according to a predetermined load sharing policy, and an actual communications signal (payload) directed to a temporary address managed by each address conversion apparatus to the relevant address conversion apparatus. Alternatively, when the correspondence notice signal or notice signal is sent from the name solution apparatus, the load sharing apparatus should transfer this signal to a specific address conversion apparatus according to a predetermined load sharing policy, and a payload signal directed to a temporary address to be once managed by all the address conversion apparatuses into the all address conversion apparatuses.

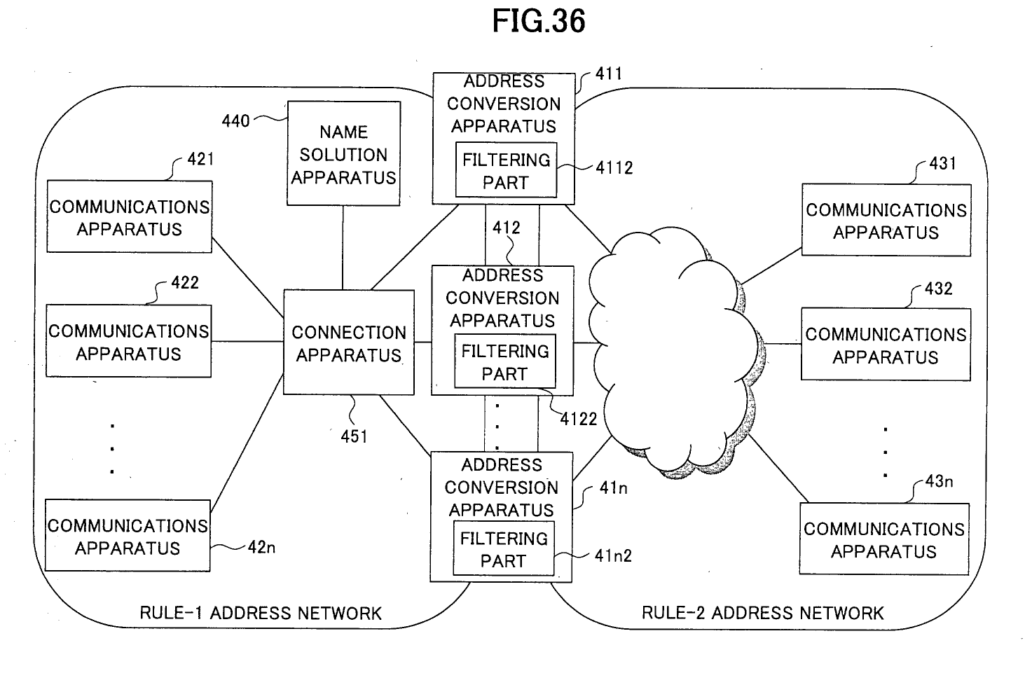

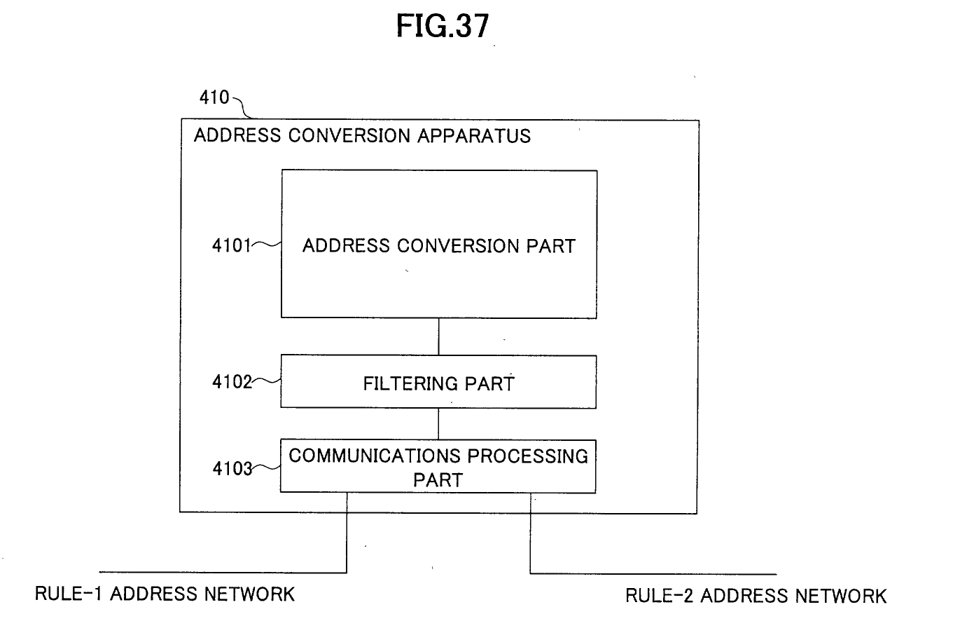

According to a fourth embodiment of the present invention, a system enabling effective load sharing processing is provided. FIG. 36 is a system configuration of the fourth embodiment of the present invention. As shown in the figure, reference numerals 411-41n represent respective address conversion apparatuses, and as shown in FIG. 37, each thereof includes an address conversion part 4101, a filtering part 4102, and a communications processing part 4103.

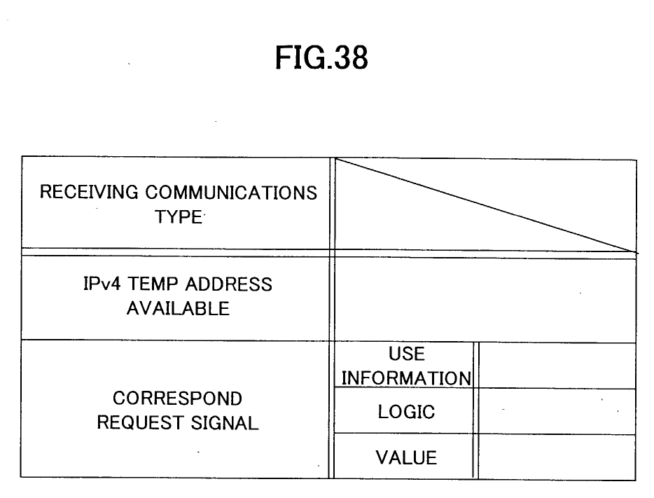

In each address conversion apparatus, a part or all information is extracted from a correspondence request signal or notice signal received by the communications processing part 4103 according to predetermined use information, logic, and value beforehand registered in a management table managed by the filtering part 4102. Then, calculation/operation is made according to the logic such that it is determined whether or not the calculation result falls within the value (see FIG. 38). When the result falls within the value, the received signal is sent to the address conversion part 4101 of its own apparatus, while the signal concerned is canceled when the result does not fall within the value.

The address conversion part 4101 receiving the signal then performs processing same as that performed by the address conversion apparatus in each embodiment described above. Thus, address conversion is performed according to correspondence information of a conversion table managing communications between the communications apparatus 421 through 42n belonging to a rule-1 (IPv4 ) address network and the communications apparatus 431 through 43n belonging to a rule-2 (IPv6 ) address network. Thereby, communications therebetween can be established.

The communications apparatuses 421-42n are communications apparatuses of the address system of rule 1, and are apparatuses which can communicate between the apparatuses in the address network of rule 1. The communications apparatus 431-43n are communications apparatuses of the address system of rule 2, and are apparatuses which can communicate between the apparatuses in the address network of rule 2 similarly.

When the address conversion apparatus 411-41n performs correspondence between the communications apparatus of rule 1, and the communications apparatus of rule 2, the name solution apparatus 440 sends to the connection apparatus 451, a correspondence request signal. On the other hand, when performing correspondence between the communications apparatus of rule 1 and the communications apparatus of rule 2 within the name solution apparatus itself, a correspondence notice signal is sent to the connection apparatus 451. The connection apparatus 441 transmits the signal sent from the name solution apparatus 440 or the communications apparatus of rule 1 to all the address conversion apparatuses 411-41n.

In the system shown in FIG. 36, as the communications apparatus 421-42n of rule 1, personal computers, PDAs, cellular phones or the like according to IPv4 address system may be used. As the communications apparatus 431-43n of rule 2, personal computers, PDAs, cellular phones or the like according to IPv6 address system may be used. As the name solution apparatus 440, a DNS or the like may be used. As the connection apparatus 451, a switching hub or the like may be used. As the address conversion apparatuses 411-41n, gateways, etc. may be applied.

The address conversion part 4101, the filtering part 4102, and the communications processing part 4103 of each address conversion apparatus may be provided as hardware units mounted into a computer of the like. Alternatively, these functional units may be provided as combinations of hardware and software mounted.

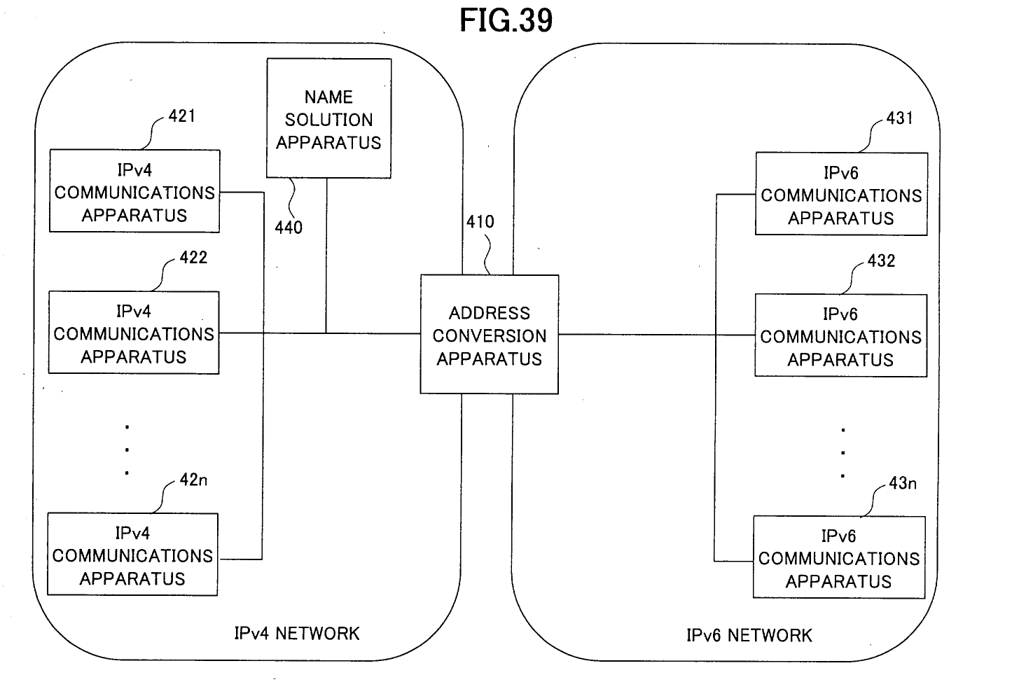

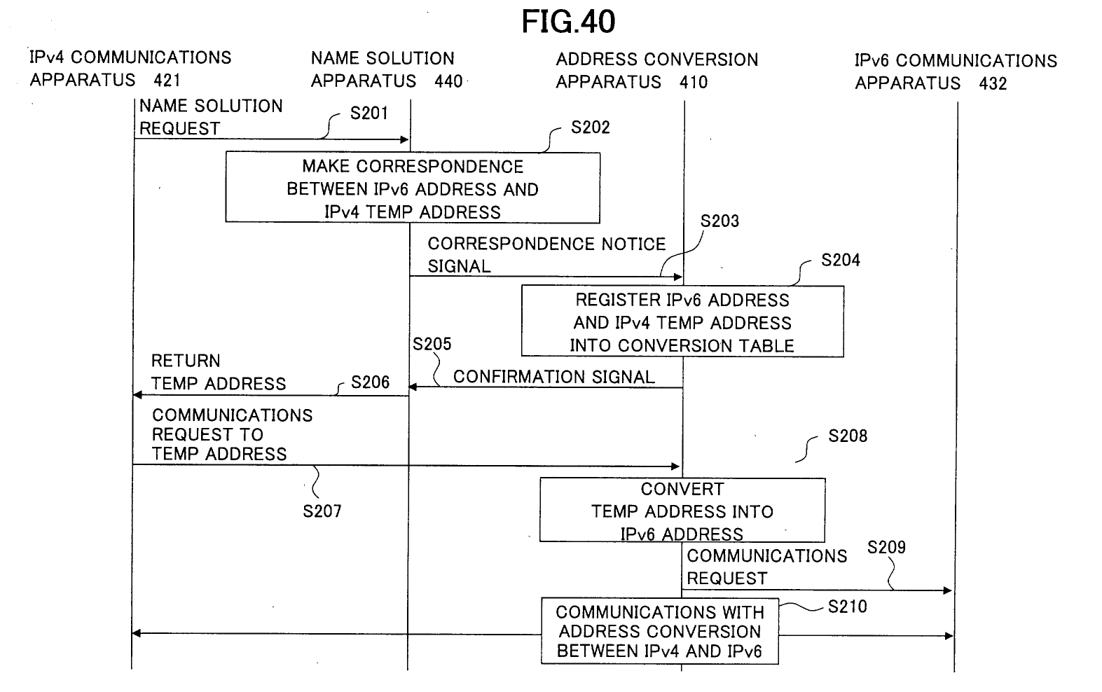

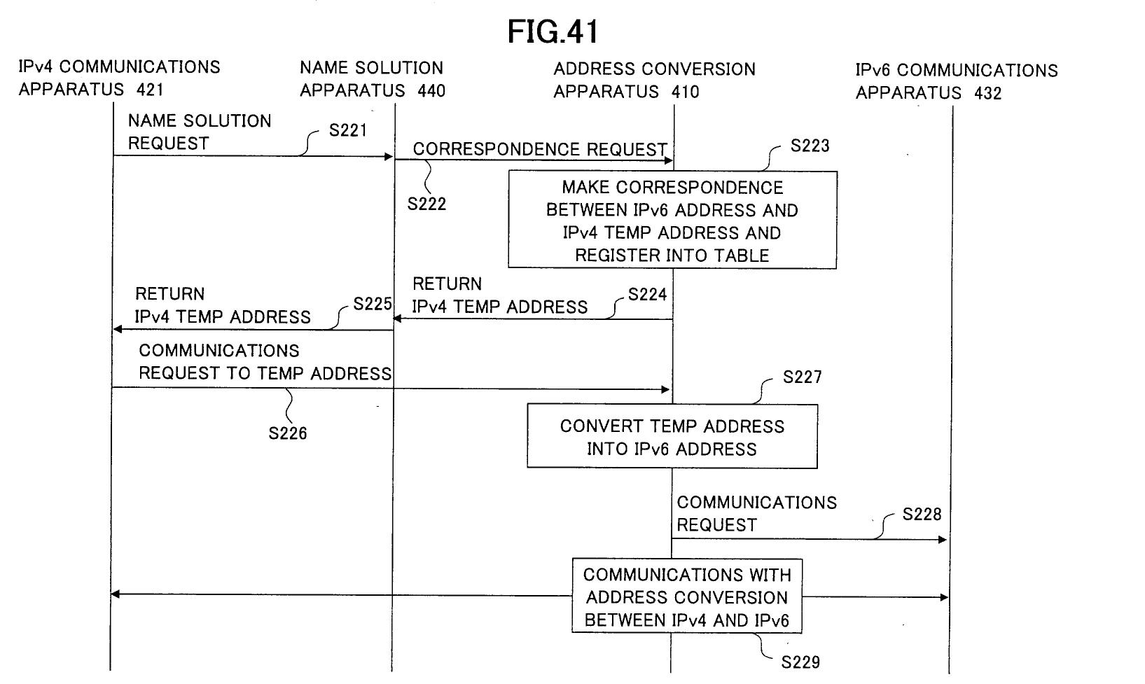

Before detailed description of the fourth embodiment of the present invention, the configurations of the above-mentioned first and second embodiments of the present invention will now be described again with reference to FIGS. 39 through 41. Namely, for example, different communications address systems or different communications address management systems are assumed as belonging to an IPv4 network and an IPv6 network, respectively.

A name solution request signal for an address of IPv6 communications apparatus 432 is first transmitted to the name solution apparatus 440 from an IPv4 communications apparatus 421 so as to establish communications from an IPv4 communications apparatus 421 to an IPv6 communications apparatus 432 (in steps S201 and S221).

In the name solution apparatus 440, when performing correspondence of an address of the IPv6 communications apparatus 432 with a temporary address of IPv4 network by itself, a corresponding notice signal indicating the correspondence result is sent to the address conversion apparatus 410 in a step S202. On the other hand, when correspondence of the address of IPv6 communications apparatus 432 with the temporary address of IPv4 network is to be performed by the address conversion apparatus 410, and a correspondence request signal is transmitted to the address conversion apparatus 410 (in a step S222). The address conversion apparatus 410 is set up so that it can receive not only a signal directed to the address of its own but also a signal directed to an address of a temporary address group which the apparatus holds.

When the above-mentioned correspondence request signal is received (in a step S222), a temporary address 1 currently available is registered for the address of IPv6 communications apparatus 432 with a correspondence therebetween (in a step S223). The temporary address 1 is sent as a reply of the correspondence request signal to the name solution apparatus 440 (in a step S224). The name solution apparatus 440 returns the temporary address 1 to the IPv4 communications apparatus 421 as a name solution result (in a step S225), and the IPv4 communications apparatus 421 then sends out a communications request directed to the temporary address 1 (in a step S226).

The address conversion apparatus 410 receives the signal directed to the temporary address 1 , and converts it into the address of the IPv6 communications apparatus based on the registered correspondence information, and sends a corresponding communications request to the IPv6 network (in steps S227 and S228).

On the other hand, when the address conversion apparatus 410 receives the correspondence notice signal (in a step S203), the address of the IPv6 communications apparatus 432 and the temporary address 1 of IPv4 network within the correspondence notice signal are registered there (in a step S204), and a confirmation signal is returned to the name solution apparatus 440 (in a step S205).

The name solution apparatus 440 returns the temporary address 1 as a name solution result to the IPv4 communications apparatus 421, when receiving the confirmation signal (in a step S206). The IPv4 communications apparatus 421 then issues a communications request using the temporary address 1 of IPv4 network returned from the name solution apparatus 440 (in a step S207).

The address conversion apparatus 410 receives the signal directed to the temporary address 1, converts the address thereof into the address of the IPv6 communications apparatus according to the registered correspondence information, and, therewith, issues a communications request to the IPv6 network (in a step S208).

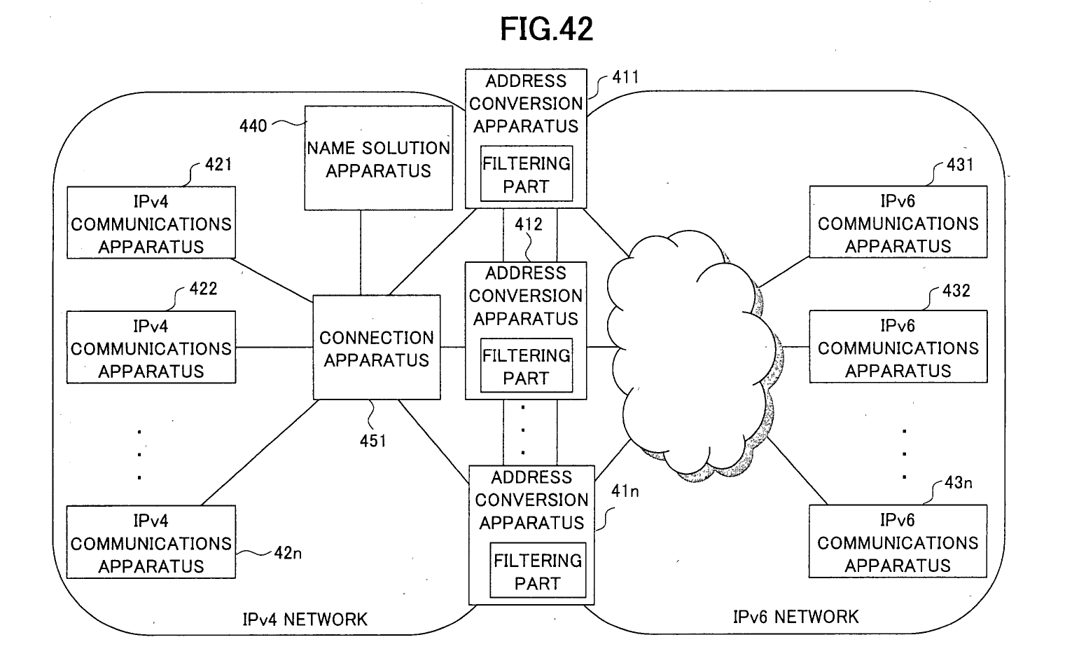

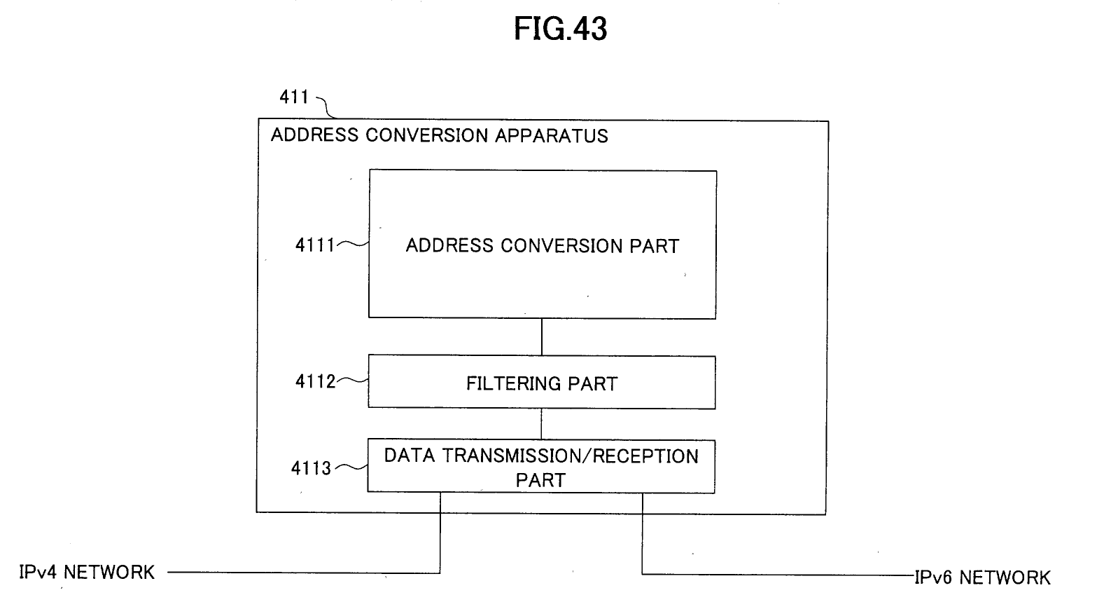

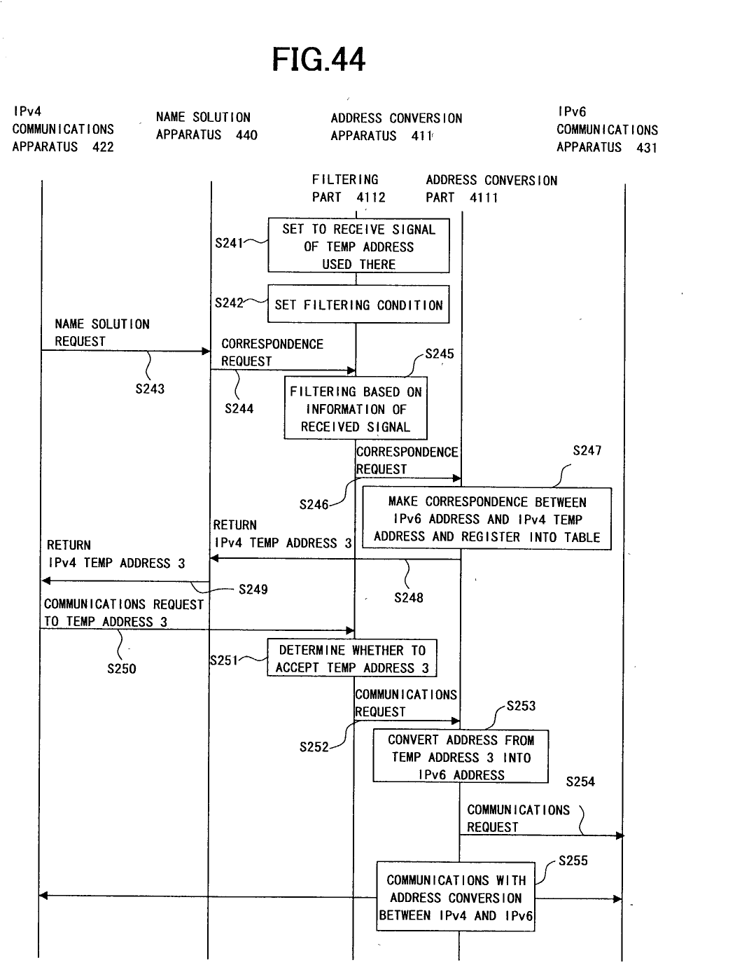

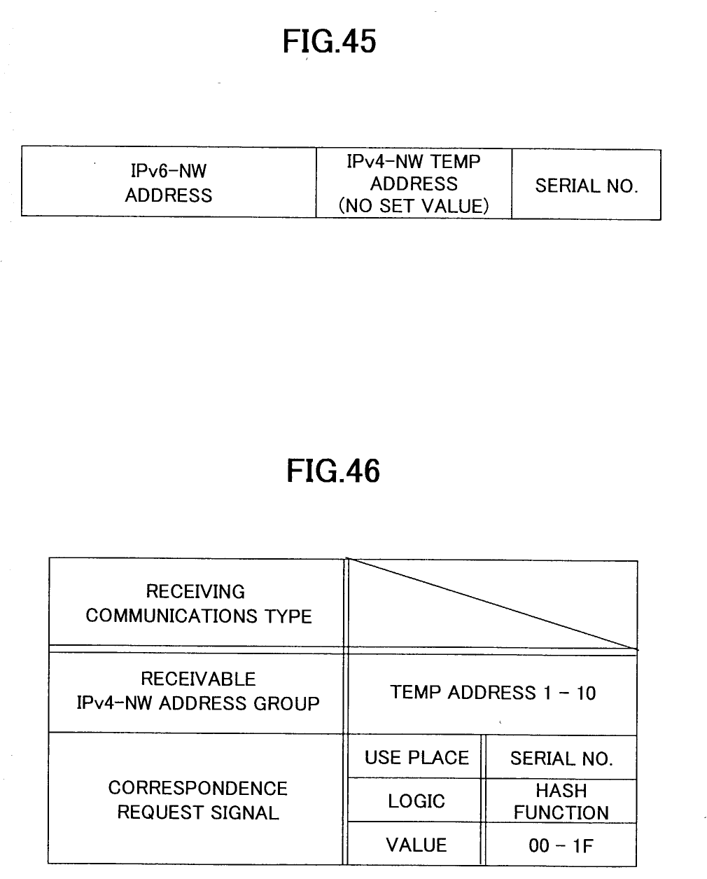

In contrast to the above-described first and second embodiments of the present invention, FIG. 42 shows a system configuration of the above-mentioned fourth embodiment of the present invention. FIG. 43 shows a configuration of each address conversion apparatus. FIG. 44 shows a flow chart of operation performed by the fourth embodiment. FIG. 45 shows a correspondence request signal. FIG. 46 shows a management table of a filtering part 4112.

In the fourth embodiment of the present invention, a name solution request signal for an address of IPv6 communications apparatus 431 is first sent to the name solution apparatus 440 from the IPv4 communications apparatus 422 to communicate from the IPv4 communications apparatus 422 to the IPv6 communications apparatus 431, for example (in a step S243). The name solution apparatus 440 transmits a correspondence request signal concerned to the connection apparatus 451. The connection apparatus 451 sends the correspondence request signal concerned to all the address conversion apparatus 411-41n.

As shown in FIG. 46, a set value is beforehand provided for every receiving communications type in the management table which each address conversion apparatus 411-41n has in the filtering part 4112 thereof. Further, IPv4 network temporary addresses managed in the address conversion part 4111 are beforehand set as a receivable IPv4 network address group. And, in the correspondence request signal item thereof, which logic is to be applied to which part of a received correspondence request signal, and which range of calculation result is allowed for accepting and thus transferring the signal concerned to the address conversion part 411 are set beforehand (in steps S241 and S242). The signal is canceled when the calculation result does not fall within the range of value (in a step S245).

According to the fourth embodiment, each address conversion apparatus 411-41n calculates a Hash function which is the logic prescribed in the above-mentioned management table for the serial No. of a given correspondence request signal (see the FIG. 45). The result of the calculation is assumed as “1A”, for example. According to the calculation result of the Hash function concerned, the filtering part of each of the address conversion apparatus 412-41n cancels the received correspondence request signal, while only the filtering part 4112 of the address conversion apparatus 411 accepts and thus transfers the correspondence request signal to the address conversion part 4111 (in a step S246), for example.

The address conversion part 4111 then registers the IPv6 network address 431 included in this correspondence request signal, and an IPv4 network temporary address 3 currently available, for example, into the conversion table (in a step S247), and sends the above-mentioned IPv4 network temporary address 3 to the name solution apparatus 440 as a reply to the correspondence request signal (in a step S248). The name solution apparatus 440 returns the IPv4 network temporary address 3 to the IPv4 communications apparatus 422 as a name solution result (in a step S249), and the IPv4 communications apparatus 422 then sends out a communications request using the IPv4 network temporary address 3 (in a step S250).

The signal of the IPv4 network temporary address 3 is sent to all the address conversion apparatuses 411-41n via the connection apparatus 451. Then, the receivable IPv4 network address group registered in the management table in the filtering part 4112 is searched by each address conversion apparatus (in a step S251). Then, when there is a relevant address in any address conversion apparatus, the received signal is accepted and then transferred to the address conversion part of the relevant address conversion apparatus (in a step S252). However, for any address conversion apparatus in which there is no relevant address, the signal is cancelled therein.

In this example, the filtering part 4112 of only the address conversion apparatus 411 accepts and thus transfers the received signal to its own address conversion part 4111 (in a step S252). However, in any other address conversion apparatus 412 through 41n, the filtering part cancels the received signal. And, then, the address conversion part 4111 of the address conversion apparatus 411 converts the IPv4 network temporary address received into the address of the IPv6 communications apparatus 431 according to the correspondence information registered in the registration table. Then, it sends a communications request to the IPv6 communications apparatus 431 of IPv6 network, and thus, communications between the IPv4 communications apparatus 422 and the IPv6 communications apparatus 431 is attained.

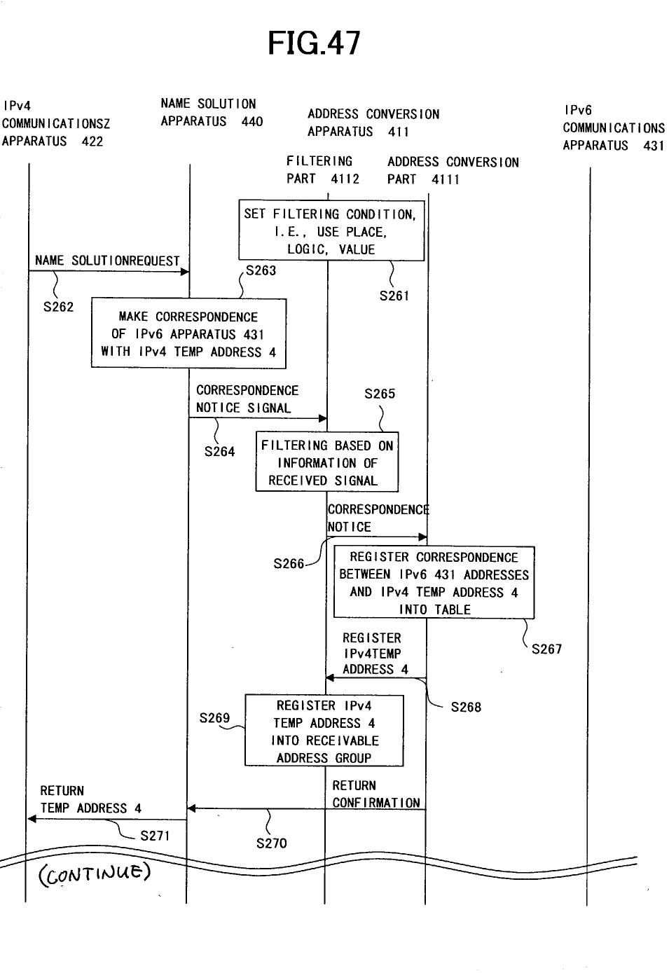

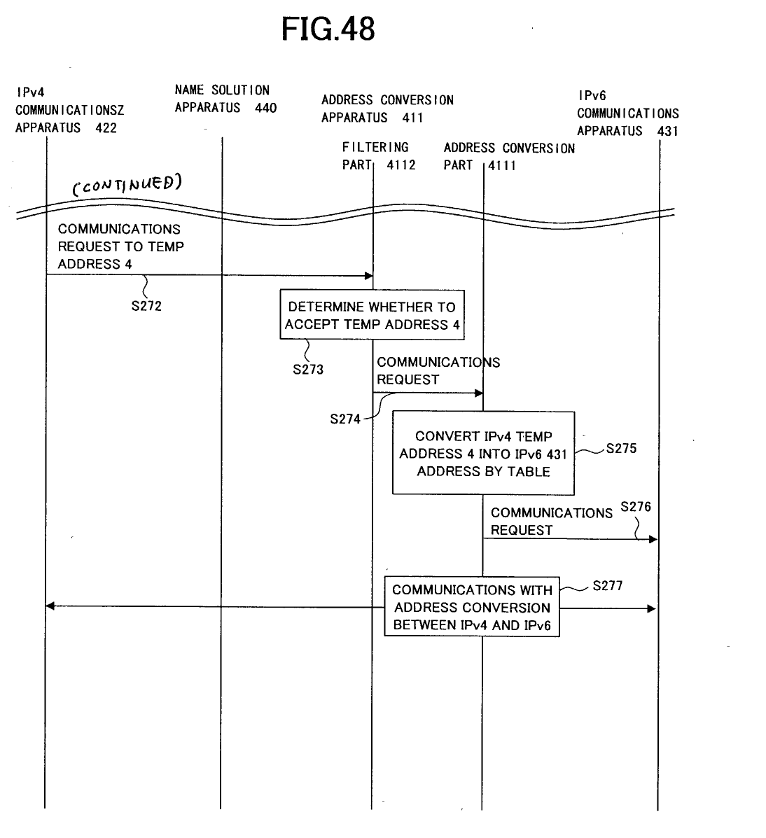

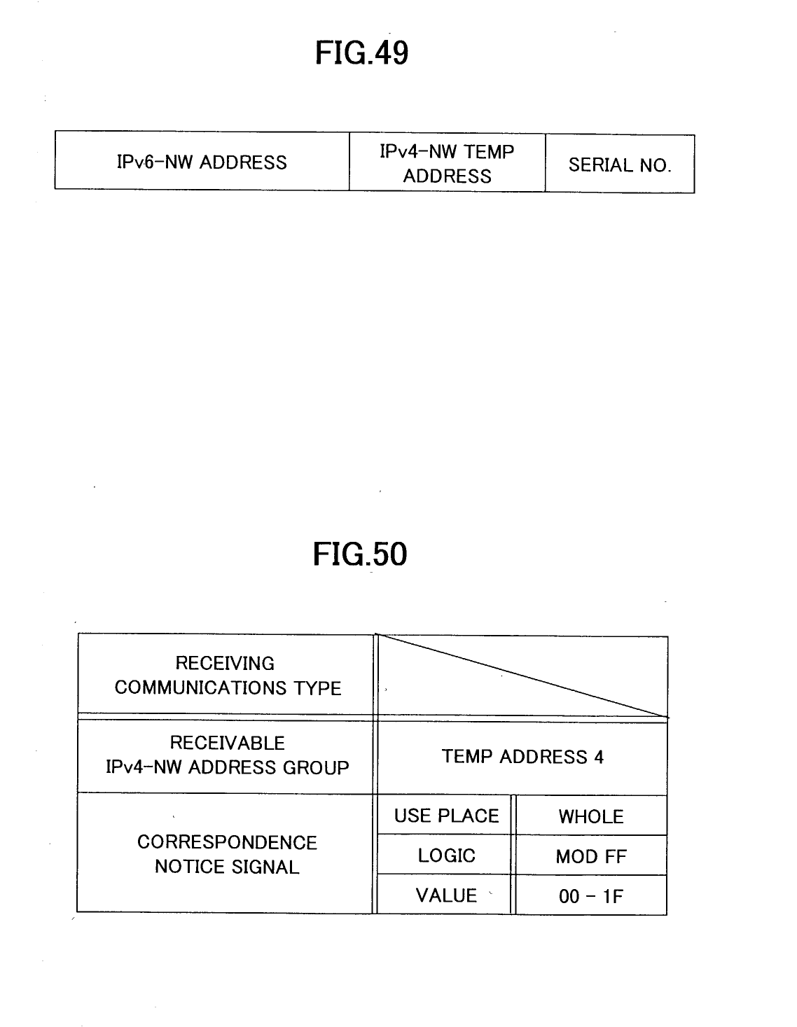

A fifth embodiment of the present invention which is a variant of the above-described fourth embodiment will now be described. The fifth embodiment has the same system configuration as that of the fourth embodiment shown in FIG. 42. FIG. 47 and FIG. 48 show a flow chart of operation according to the fifth embodiment, FIG. 49 shows a correspondence notice signal according to the fifth embodiment, and FIG. 50 shows a management table of the filtering part according to the fifth embodiment.

For example, a name solution request signal for an address of IPv6 communications apparatus 431 is first sent to the name solution apparatus 440 from the IPv4 communications apparatus 422 to communicate from the IPv4 communications apparatus 422 to the IPv6 communications apparatus 431 (in a step S262). The name solution apparatus 440 selects a currently available IPv4 network temporary address, and manages the matter of giving the correspondence with this IPv4 network temporary address (in a step S262), sets the address of IPv6 communications apparatus 431 and the IPv4 network temporary address into the correspondence notice signal, and transmits the signal to the connection apparatus 451 (see FIG. 49).

The connection apparatus 451 sends the same correspondence notice signal to all the address conversion apparatuses 411-41n (in a step S264). A set value for every reception communications type is beforehand provided in the management table of the filtering part of each address conversion apparatuses 411-41n (see FIG. 50). Further, in the correspondence notice signal item of the management table, beforehand set is which part of the correspondence signal is to be applied, which logic should be applied thereto, and what range of value the calculation result should fall within so as to accept the signal (in a step S261). The signal is canceled when the calculation result does not fall within the range of value.

According to the fifth embodiment, each of the address conversion apparatuses 411-41n calculates the remainder after performing division operation on all the information of the received correspondence notice signal by “FF” which is the logic specified beforehand in the management table as shown. The result is assumed as being “1A”, for example. In this case, according to the same calculation of the remainder, the filtering part of each of the address conversion apparatuses 412-41n cancels the received correspondence notice signal, while the filtering part 4112 of only the address conversion apparatus 411 accepts and thus transfers the same signal to the address conversion part 4111 its own without canceling it (in steps S265 and S266). Setting of the filtering part of each of the respective address conversion apparatuses is made such that only one specific address conversion apparatus actually handles the signal while any other ones cancels the same.

The relevant address conversion part 4111 extracts the IPv4 network temporary address 4 from the correspondence notice signal concerned, registers this into the receivable IPv4 network temporary address group of the filtering part 4112 and also to the conversion table of the address conversion part 4111 as shown (in steps S268 and S269), and sends a confirmation signal as a reply to the correspondence notice signal to the name solution apparatus 440 (in a step S270). The name solution apparatus 440 returns the above-mentioned IPv4 network temporary address 4 as a name solution result to the IPv4 communications apparatus 422 (in a step S271).

The IPv4 communications apparatus 422 thus sends out a communications request using the above-mentioned IPv4 network temporary address 4. The signal of this IPv4 network temporary address 4 is then sent to all the address conversion apparatuses 411-41n by the connection apparatus 451 (in a step S272), and the receivable IPv4 network address group registered in the management table in the filtering part is searched for in each address conversion apparatus.

When there occurs the relevant address as a result, the received signal is accepted and transferred to the address conversion part 4111 of own apparatus, while the received signal is canceled in any address conversion apparatus in which there occurs no relevant address as a result(in a step S273). Since the IPv4 network temporary address 4 is registered only in the filtering part 4112 of the address conversion apparatus 411 by the above-mentioned processing in this example, the received signal is accepted and transferred to the address conversion part 4111 (in a step S274) there, and the filtering part in any other address conversion apparatus cancels the received signal.

The address conversion part 4111 receiving the signal then converts the IPv4 network temporary address of the received data into the address of the IPv6 communications apparatus 431 according to the registration table thereof, sends a communications request for the IPv6 communications apparatus 431 in the IPv6 network (in steps S275 and S276), and thus communications between the IPv4 communications apparatus 422 and the IPv6 communications apparatus 431 is attained.

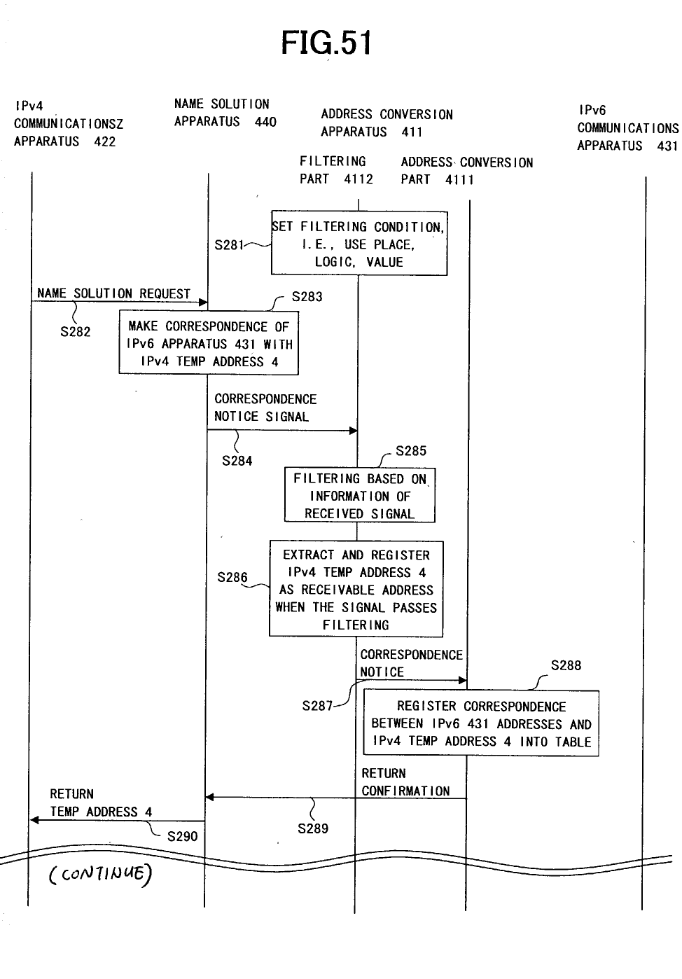

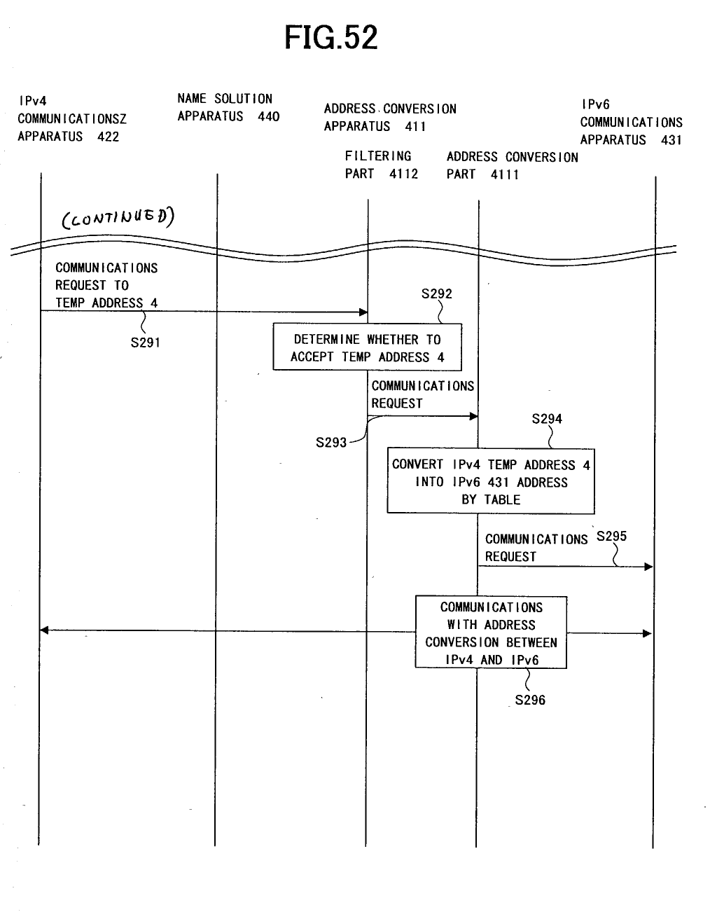

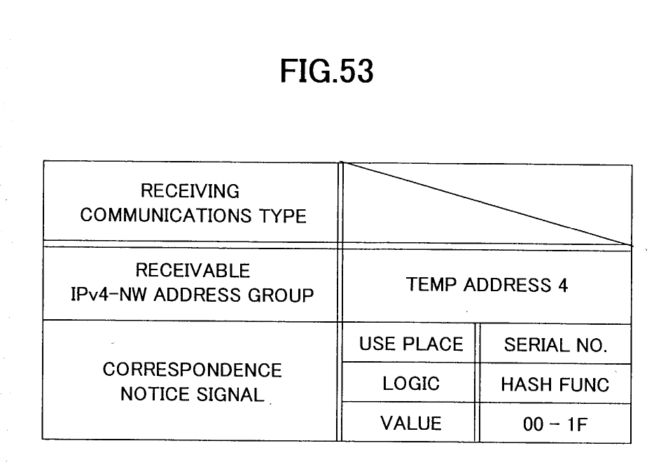

A sixth embodiment as a further variant of the above-described fourth and fifth embodiments of the present invention will now be described. The sixth embodiment of the present invention has the same system configuration as that of the fourth and fifth embodiments, FIGS. 51 and 52 shows an operation flow chart thereof. The correspondence notice signal shown in FIG. 49 is also used, and also, the management table of the filtering part shown in FIG. 53 is used.

A name solution request signal for an address of IPv6 communications apparatus 431 is first sent to the name solution apparatus 440 from the IPv4 communications apparatus 422 as in the above-mentioned embodiments to communicate from the IPv4 communications apparatus 422 to the IPv6 communications apparatus 431 (in a step S282). The name solution apparatus 440 chooses an IPv4 network temporary address currently available, and gives a correspondence thereof with the relevant request signal (in a step S283), manages this matter on a table, sets the address of the IPv6 communications apparatus 431 and the selected IPv4 network temporary address into a correspondence notice signal (see FIG. 49), and transmits it to the connection apparatus 451. The connection apparatus 451 transfers the same correspondence notice signal to all the address conversion apparatuses 411-41n.

A set value for every reception communications type is beforehand provided in a management table (see FIG. 53) of each of the address conversion apparatuses 411-41n. Also in a correspondence notice signal item thereof, what logic is to be applied to which part of a received correspondence notice signal, and what range of value a calculation result of the logical operation should fall within to accept the received data to be transferred to the address conversion part of its own (in a step S281). The received signal is canceled when the calculation result does not fall within the range of value.

According to the sixth embodiment, each of the address conversion apparatuses 411-41n calculates the Hash function which is the logic beforehand specified in the management table onto the serial No. of the correspondence notice signal concerned. The result of the calculation is assumed as being “1A”, for example. According to the calculation result of this Hash function, the filtering part of each of the address conversion apparatuses 412-41n cancels the received correspondence request signal, while only the filtering part 4112 of the address conversion apparatus 411 accepts and transfers the same into the address conversion part 4111 of its own apparatus without canceling it (in steps S285, S286, and S287).

At this time, the filtering part 4112 extracts the IPv4 network temporary address 4 from the correspondence notice signal, and registers it into the receivable IPv4 network temporary address group thereof (in a step S286). The address conversion part 4111 extracts the IPv4 network temporary address 4 from the correspondence notice signal, and registers it into the conversion table of the address conversion part 4111 (in a step S288), and sends a confirmation signal as a reply on the correspondence notice signal to the name solution apparatus 440 (in a step S289).

The same operations as in the above-described fifth embodiment are then performed (in step S290 through S296).

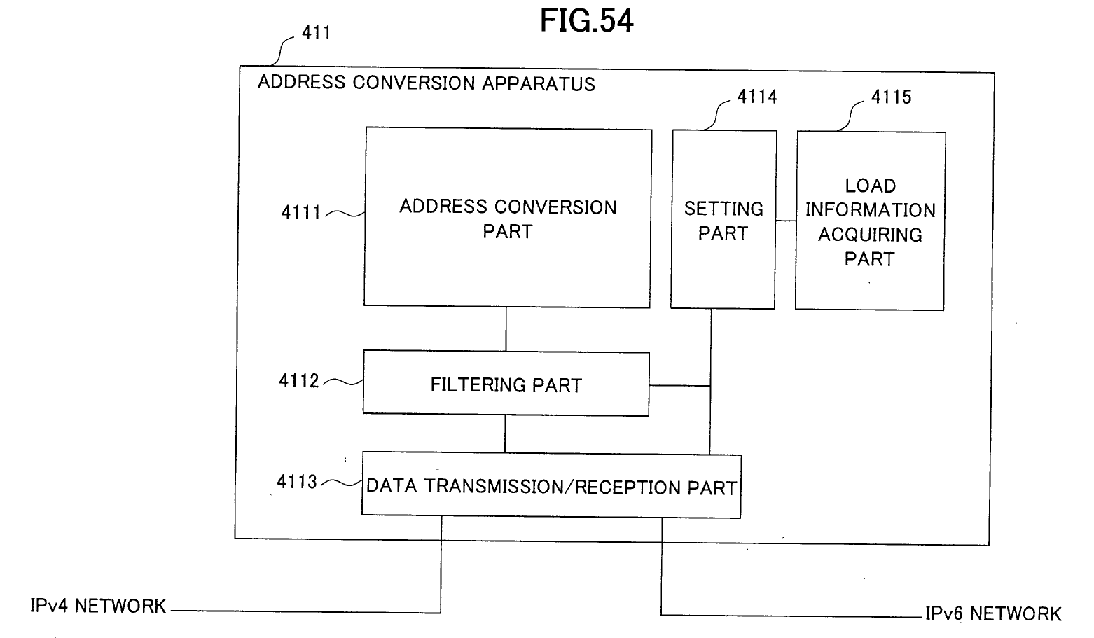

FIG. 54 shows a configuration of an address conversion apparatus 411 according to a seventh embodiment of the present invention applicable to each of the above-mentioned fourth through sixth embodiments of the present invention. Here, a load information acquisition part 4115 investigates the rate of CPU load and the rate of memory usage of the address conversion apparatus of its own, and notifies the information to a setting part 4114.

The setting part notifies the rate of CPU load and the rate of memory usage to other address conversion apparatuses through a data transmission/reception part 4113, and, also, receives rates of CPU load and rates of memory usage of other address conversion apparatuses. For example, when the address conversion apparatus 411 acts as a main address conversion apparatus, the setting part 4114 thereof calculates sharing rates of the processing load based on the rates of CPU load and the rates of memory usage sent from the respective address conversion apparatuses 412-41n, and the rate of CPU load and the rate of memory usage of the own apparatus acquired from the own load information acquisition part 4115.

A numerical value as a determination criterion to be set with respect to the value of the correspondence request signal or the correspondence notice signal of the filtering parts 4112-41n2 for the above-mentioned acceptance calculation are notified to the setting parts 4124-41n4 of the respective address conversion apparatuses 412-41n. Similarly, the numerical value newly determined is set into the own filtering part 4112. Also, the setting parts 4124-41n4 of the respective address conversion apparatuses 412-41n set the received new numerical values into their own filtering parts 4122-41n4, respectively, as the determination criteria used for their own acceptance calculation for determining whether or not a received signal is accepted as being processed by utilization of their own resources.

Thereby, load sharing according to a new policy based on the thus-set numerical values can be achieved. And, since the policy reflects the current actual processing load situation in each address conversion apparatus, it becomes possible to efficiently use the respective address conversion apparatuses as processing operation resources.

Thus, according to the present invention in the aspect described above with reference to the fourth through seventh embodiments, a special load sharing apparatus in a form of hardware becomes unnecessary, and, also, complicate communications setting with respect to various items of setting in the respective address conversion apparatuses becomes unnecessary, merely by providing the filtering part in each of the address conversion apparatuses.

Further, the present invention is not limited to the above-described embodiments, and variations and modifications may be made without departing from the scope of the present invention.

The present application is based on Japanese priority applications Nos. 2001-325740, 2002-176788 and 2002-298827, filed on Oct. 24, 2001, Jun. 18, 2002 and Oct. 11, 2002, respectively, the entire contents of which are hereby incorporated by reference.

What is claimed is

1. A communications system for performing communications between a plurality of communications networks having different address systems, comprising:
a registering part registering a combination of at least any one of an address and a predetermined application identifier of a terminal on one communications network with an address of a terminal on another communications network; and
an address converting part performing address conversion according to the contents of registration made by said registering part.

2. An address conversion apparatus which performs address conversion in communications between a plurality of communications networks having different address systems, comprising:
an address converting part performing address conversion in accordance with a combination of at least any one of an address and a predetermined application identifier of a terminal on one communications network with an address of a terminal on another communications network; and
a converting part to perform address conversion according to the contents of registration made by said registering part.

3. A name solution apparatus which converts a name of a terminal with which communications are to be made into a relevant address in communications between a plurality of communications networks having different address systems, comprising:
a name solving part obtaining a predetermined correspondence for a relevant address from a combination of at least any one of an address and a predetermined application identifier of a terminal on one communications network with an address of a terminal on another communications network.

4. The name solution apparatus as claimed in claim 3, further comprising a notifying part notifying an address conversion apparatus of the correspondence for address conversion obtained by said name solving part.

5. The communications system as claimed in claim 1, further comprising a deleting part deleting combined information registered by said registering part after a predetermined time interval has elapsed since a latest relevant communications started.

6. The communications system as claimed in claim 1, further comprising:
an allocating part allocating a temporary address according to an address system of one communications network for an address according to an address system of another communications network,
wherein said registering part registers, for the temporary address, at least any one of the address of the terminal of the one communications network and the predetermined relevant application identifier together.

7. The communications system as claimed in claim 1, wherein:
registration of at least any one of the address and the predetermined application identifier of the terminal of the one communications network is performed at a time of start of relevant communications by referring to communications data sent from said terminal of the one communications network.

8. The address conversion apparatus as claimed in claim 2, wherein:
registration of at least any one of the address and the predetermined application identifier of the terminal of the one communications network is performed at a time of start of relevant communications by referring to communications data sent from said terminal of the one communications network.

9. A communications system for performing communications between a plurality of communications networks having different address systems, comprising:
a registering part registering a combination of at least any one of an address and a predetermined application identifier of a terminal on one communications network with an address of a terminal on another communications network; and
an address converting part performing address conversion according to the contents of registration made by said registering part,
wherein
registration of at least any one of the address and the predetermined application identifier of the terminal of the one communications network is performed at a time of start of relevant communications by referring to communications data sent from the terminal of the one communications network.

10. An address conversion apparatus used in performing communications from a first communications apparatus which performs communications by using addresses according to a first rule for a second communications apparatus which performs communications by using addresses according to a second rule, comprising:
a correspondence address determining part allocating a temporary address according to the first rule for the second communications apparatus;
an address conversion table storage part storing an address conversion table for storing, with a correspondence therebetween, the address of the first communications apparatus as a communications source, the temporary address allocated by said correspondence address determining part and an address of the second communications apparatus according to the second rule;
a data receiving part receiving communications according to the first rule from the first communications apparatus for the temporary address;
an address converting part converting the communications for the temporary address into communications for the address of the second communications apparatus according to the second rule according to the address conversion table stored by said address conversion table storage part; and
a data transmitting part transmitting the communications from the first communications apparatus converted by said address converting part to the second communications apparatus,
wherein:
said address conversion table storage part holds the address of the first communications apparatus as a suspended state during an interval from when said address determining part allocates the temporary address for the second communications through when the first communications apparatus starts communications with the second communications apparatus by using the temporary address thereof.

11. The address conversion apparatus as claimed in claim 10, wherein:
during the interval from when said address determining part allocates the temporary address for the second communications through when the first communications apparatus starts communications with the second communications apparatus by using the temporary address thereof, said temporary address is not used for a new allocation for a second communications apparatus.

12. The address conversion apparatus as claimed in claim 10, wherein:
after a predetermined time interval has elapsed while no communications are performed for the second communications apparatus by using the temporary address from the first communications apparatus since the temporary address is once allocated for the second communications apparatus, said temporary address is allowed to be used for new allocation for a second communications apparatus.

13. The address conversion apparatus as claimed in claim 10, wherein:
said address conversion table storage part stores, with a correspondence therebetween, a transmission port number for the communications of the first communications apparatus, in addition to the address of the second communications apparatus, the temporary address for the second communications apparatus and the address of the first communications apparatus; and
when the temporary address is allocated for the second communications apparatus, the transmission port number for the relevant communications is registered for the temporary address.

14. An address conversion apparatus used in performing communications from a first communications apparatus which performs communications by using addresses according to a first rule for a second communications apparatus which performs communications by using addresses according to a second rule, comprising:
a correspondence address determining part allocating a temporary address according to the first rule for the second communications apparatus;
an address conversion table storage part storing an address conversion table for storing, with a correspondence therebetween, the address of the first communications apparatus as a communications source, the temporary address allocated by said correspondence address determining part and an address of the second communications apparatus according to the second rule;
a data receiving part receiving communications according to the first rule from the first communications apparatus for the temporary address;
an address converting part converting the communications for the temporary address into communications for the address of the second communications apparatus according to the second rule according to the address conversion table stored by said address conversion table storage part; and
a data transmitting part transmitting the communications from the first communications apparatus converted by said address converting part to the second communications apparatus,
wherein:
when the first communications apparatus performs communications with the second communications apparatus by indicating the temporary address, the address of the first communications apparatus which has thus started the communications is registered in the address conversion table for said temporary address.

15. The address conversion apparatus as claimed in claim 14, wherein the start of communications from the first communications apparatus is determined from a communications start command issued for the temporary address of the second communications apparatus.

16. The address conversion apparatus as claimed in claim 14, wherein:
wherein the start of communications from the first communications apparatus is determined from a fact that communications are performed for the temporary address of the second communications apparatus by using a specific reserved port number.

17. The address conversion apparatus as claimed in claim 14, wherein:
said address conversion table storage part stores, with a correspondence therebetween, a transmission port number by which a plurality of occasions of communications on the same first communications apparatus can be distinguished, in addition to the address the second communications apparatus, the temporary address for the second communications apparatus, and the address of the first communications apparatus; and
when the first communications apparatus performs communications with the second communications apparatus by indicating the temporary address, the address of the first communications apparatus which has started the communications is registered with the address conversion table storage part for said temporary address, and, also, the transmission port number of the same communications is registered with the address conversion table storage part for said temporary address.

18. An address conversion apparatus used in performing communications from a first communications apparatus which performs communications by using addresses according to a first rule for a second communications apparatus which performs communications by using addresses according to a second rule, comprising:
a correspondence address determining part allocating a temporary address according to the first rule for the second communications apparatus for an address of the first communications apparatus;
an address conversion table storage part storing an address conversion table for storing, with a correspondence therebetween, the address of the first communications apparatus as a communications source, the temporary address allocated by said correspondence address determining part and an address of the second communications apparatus according to the second rule;
a data receiving part receiving communications according to the first rule from the first communications apparatus for the temporary address;
an address converting part converting the communications for the temporary address into communications for the address of the second communications apparatus according to the second rule according to the address conversion table stored by said address conversion table storage part; and
a data transmitting part transmitting the communications from the first communications apparatus converted by said address converting part to the second communications apparatus,
wherein:
said address conversion table storage part stores, with a correspondence therebetween, a transmission port number by which a plurality of occasion of communications on the same first communications can be distinguished, in addition to the address of the second communications apparatus, the temporary address for the second communications apparatus and the address of the first communications apparatus; and
when the first communications apparatus starts communications by indicating the temporary address, address conversion is performed on the communications such that the communications be directed to the address of the second communications apparatus for which the registered information with the address conversion table storage part is coincident with said temporary address and the transmission port number included in the communications sent from the first communications apparatus.

19. A communications system for performing communications between a plurality of communications networks having mutually different address systems, comprising:
a plurality of address conversion parts each performing address conversion between the mutually different address systems in communications between the plurality of communications networks; and
a filtering part determining one of the plurality of address conversion parts by which address conversion is actually performed, for each occasion of communications.

20. The communications system as claimed in claim 19, wherein:
said filtering part performs control such as that only one of the address conversion parts thus determined receive an address correspondence request, an address thus obtained through the address conversion being responded to the address correspondence request.

21. The communications system as claimed in claim 19, wherein:
said filtering part performs control such as that said only one of the address conversion part thus determined receive an address correspondence notice, the address conversion part which has thus received the address correspondence notice registering an address correspondence according to the notice so that a signal directed to a relevant address can be then received.

22. The communications system as claimed in claim 19, wherein:
said filtering part performs control such as that only said one of the address conversion part thus determined receive an address correspondence notice, the filtering part of the address conversion part which has thus received the address correspondence notice extracting an address from the notice so that a signal directed to the relevant address can be then received.

23. The communications system as claimed in claim 19, further comprising:
a communications part communicating processing load conditions of the respective address conversion parts,
wherein:
said filtering part controls load sharing rates on the address conversion parts for every occasions of communications according to the processing load conditions thus obtained via said communicating part.

24. The communications system as claimed in claim 1, wherein:
said address converting part comprises a plurality of address converting parts each performing address conversion between the mutually different address systems in communications between the plurality of communications networks; and
a filtering part determining one of the plurality of address conversion parts by which address conversion is actually performed, for each occasion of communications.

25. The communications system as claimed in claim 24, further comprising:
a communications part communicating processing load conditions of the respective address conversion parts,
wherein:
said filtering part controls load sharing rates of the address conversion parts for every occasions of communications according to the processing load conditions thus obtained via said communicating part.

26. The communications system as claimed in claim 19, wherein:
said filtering part comprises a plurality of filtering parts; and
each of the filtering parts determines an address conversion part performing the address conversion from said plurality of address conversion parts.

27. A communications method for performing communications between a plurality of communications networks having different address systems, comprising:
a registering step of registering a combination of at least any one of an address and a predetermined application identifier of a terminal on one communications network with an address of a terminal on another communications network; and
an address converting step of performing address conversion according to the contents of registration made by said registering step.

28. The communications method as claimed in claim 27, further comprising:
an allocating step of allocating a temporary address according to an address system of one communications network for an address according to an address system of another communications network,
wherein, in said registering step, for the temporary address, at least either one of the address of the terminal of the one communications network and the predetermined relevant application identifier, and the address of the terminal of another communications network are registered together.

29. The communications method as claimed in claim 27, wherein:
registration of at least either one of the address and the predetermined application identifier of the terminal of the one communications network is performed at a time of start of relevant communications by referring to communications data sent from the terminal of the one communications network.

30. An address conversion method used in performing communications from a first communications apparatus which performs communications by using addresses according to a first rule for a second communications apparatus which performs communications by using addresses according to a second rule, comprising:
a correspondence address determining step of allocating a temporary address according to the first rule for the second communications apparatus;
an address conversion table storage step of storing an address conversion table for storing, with a correspondence therebetween, the address of the first communications apparatus as a communications source, the temporary address allocated in said correspondence address determining step and an address of the second communications apparatus according to the second rule;
a data receiving step of receiving communications according to the first rule from the first communications apparatus for the temporary address;
an address converting step of converting the communications for the temporary address into communications for the address of the second communications apparatus according to the second rule according to the address conversion table stored in said address conversion table storage step; and
a data transmitting step of transmitting the communications from the first communications apparatus converted in said address converting step to the second communications apparatus,
wherein:
in said address conversion table storage step, the address of the first communications apparatus is held as a suspended state during an interval from when said address determining step allocates the temporary address for the second communications through when the first communications apparatus starts communications with the second communications apparatus by using the temporary address thereof.

31. The address conversion method as claimed in claim 30, wherein:
during the interval from when the temporary address is allocated for the second communications in said address determining step through when the first communications apparatus starts communications with the second communications apparatus by using the temporary address thereof, said temporary address is not used for a new allocation for a second communications apparatus.

32. The address conversion method as claimed in claim 31, wherein:
after a predetermined time interval has elapsed while no communications are performed for the second communications apparatus by using the temporary address from the first communications apparatus since the temporary address is once allocated for the second communications apparatus, said temporary address is allowed to be used for new allocation for a second communications apparatus.

33. The address conversion apparatus as claimed in claim 31, wherein:
in said address conversion table storage step, a transmission port number for the communications of the first communications apparatus, in addition to the address of the second communications apparatus, the temporary address for the second communications apparatus and the address of the first communications apparatus, is stored with a correspondence therebetween; and
when the temporary address is allocated for the second communications apparatus, the transmission port number for the relevant communications is registered for said temporary address.

34. An address conversion method applied in performing communications from a first communications apparatus which performs communications by using addresses according to a first rule for a second communications apparatus which performs communications by using addresses according to a second rule, comprising:
a correspondence address determining step of allocating a temporary address according to the first rule for the second communications apparatus;
an address conversion table storage step of storing an address conversion table for storing, with a correspondence therebetween, the address of the first communications apparatus as a communications source, the temporary address allocated in said correspondence address determining step and an address of the second communications apparatus according to the second rule;
a data receiving step of receiving communications according to the first rule from the first communications apparatus for the temporary address;
an address converting step of converting the communications for the temporary address into communications for the address of the second communications apparatus according to the second rule according to the address conversion table stored in said address conversion table storage steps; and
a data transmitting step of transmitting the communications from the first communications apparatus converted in said address converting step to the second communications apparatus,
wherein:
when the first communications apparatus performs communications with the second communications apparatus by indicating the temporary address, the address of the first communications apparatus which has thus started the communications is registered in the address conversion table for said temporary address.

35. The address conversion method as claimed in claim 34, wherein the start of communications from the first communications apparatus is determined from a communications start command issued for the temporary address of the second communications apparatus.

36. The address conversion method as claimed in claim 34, wherein:
wherein the start of communications from the first communications apparatus is determined from a fact that communications are performed for the temporary address of the second communications apparatus by using a specific reserved port number.

37. The address conversion method as claimed in claim 34 wherein:
in said address conversion table storage step, a transmission port number by which a plurality of occasions of communications on the same first communications apparatus can be distinguished is stored with a correspondence therebetween, in addition to the address of the second communications apparatus, the temporary address for the second communications apparatus, and the address of the first communications apparatus; and
when the first communications apparatus performs communications with the second communications apparatus by indicating the temporary address, the address of the first communications apparatus which has started the communications is registered in the address conversion table storage step for said temporary address, and, also, the transmission port number of the same communications is registered in the address conversion table storage step for said temporary address.

38. An address conversion method applied in performing communications from a first communications apparatus which performs communications by using addresses according to a first rule for a second communications apparatus which performs communications by using addresses according to a second rule, comprising:
a correspondence address determining step of allocating a temporary address according to the first rule for the second communications apparatus;
an address conversion table storage step of storing an address conversion table for storing, with a correspondence therebetween, the address of the first communications apparatus as a communications source, the temporary address allocated in said correspondence address determining step and an address of the second communications apparatus according to the second rule;
a data receiving step of receiving communications according to the first rule from the first communications apparatus for the temporary address;
an address converting step of converting the communications for the temporary address into communications for the address of the second communications apparatus according to the second rule according to the address conversion table stored in said address conversion table storage step; and
a data transmitting step of transmitting the communications from the first communications apparatus converted in said address converting step to the second communications apparatus,
wherein:
in said address conversion table storage step, a transmission port number by which a plurality of occasion of communications on the same first communications can be distinguished is stored in addition to the address of the second communications apparatus, the temporary address for the second communications apparatus and the address of the first communications apparatus, with a correspondence therebetween; and
when the first communications apparatus starts communications by indicating the temporary address, address conversion is performed on the communications such that the communications be directed to the address of the second communications apparatus for which the registered information stored in the address conversion table storage step is coincident with said temporary address and the transmission port number included in the communications sent from the first communications apparatus.

39. A communications method applied to communications between a plurality of communications networks having mutually different address systems, comprising the steps of:
a) using a plurality of address conversion parts each performing address conversion between the mutually different address systems in communications between the plurality of communications networks; and
b) determining one of the plurality of address conversion parts by which address conversion is actually performed, for each occasion of communications.

40. The communications method as claimed in claim 39, further comprising the step of:
c) communicating processing load conditions of the respective address conversion parts,
wherein:
in said step b), load sharing rates on the address conversion parts are controlled for every occasion of communications according to the processing load conditions thus obtained via said step c).

41. The communications method as claimed in claim 27, wherein:
said address converting step is executed using a plurality of address converting parts each performing address conversion between the mutually different address systems in communications between the plurality of communications networks; and
said method further comprises a filtering step of determining one of the plurality of address conversion parts by which address conversion is actually performed, for each occasion of communications.

42. The communications method as claimed in claim 41, further comprising:
a communications step of communicating processing load conditions of the respective address conversion parts,
wherein:
in said filtering step, load sharing rates on the address conversion parts are controlled for every occasion of communications according to the processing load conditions thus obtained in said communicating step.

43. A program for causing a computer to perform in communications between a plurality of communications networks having different address system the functions of
a) registering, with a correspondence therebetween, at least either one of an address of terminal of one communications network and a predetermined application identifier concerning communications to be made, and an address of a terminal of another communications network; and
b) performing address conversion in accordance with the registration contents created by said function a).

44. The program claimed in claim 43, further causing the computer to perform an allocation function of allocating a temporary address according to the address system of one communications network for an address according to the address system of another communications network,
wherein:
in said registration function, at least either one of the address of one communications network and the predetermined application identifier is combined with the address of the other communications network for the temporary address.

45. The program as claimed in claim 43, wherein:
the registration of at least either one of the address of the terminal of the one communications network and the predetermined application identifier is made by referring to communications data sent from said one terminal at a time of commencement of relevant communications.

46. A program for causing a computer to perform, in communications between a plurality of communications networks having different address systems, a filtering function of:
determining one of a plurality of address conversion parts for causing the thus-determined one address conversion part to perform address conversion between the different address systems in communications made between the plurality of communications networks.

47. The program as claimed in claim 46, further causing the computer to perform a communications function of communicating processing load conditions of the respective address conversion parts,
wherein, in said filtering function, load sharing rates on the respective address conversion parts are controlled for every occasion of communications according to the processing load conditions of the respective address conversion parts thus obtained by said communications function.

48. A computer-readable information recording medium for storing a program for causing a computer to perform in communications between a plurality of communications networks having different address system the functions of
a) registering, with a correspondence therebetween, at least either one of an address of terminal of one communications network and a predetermined application identifier concerning communications to be made, and an address of a terminal of another communications network; and
b) performing address conversion in accordance with the registration contents created by said function a).

49. The information recording medium as claimed in claim 48, wherein said program further causes the computer to perform an allocation function of allocating a temporary address according to the address system of one communications network for an address according to the address system of another communications network,
wherein:
in said registration function, at least either one of the address of one communications network and the predetermined application identifier is combined with the address of the other communications network for the temporary address.

50. The program as claimed in claim 48,
wherein:
in the registration function, the registration of at least either one of the address of the terminal of the one communications network and the predetermined application identifier is made by referring to communications data sent from said one terminal at a time of commencement of the relevant communications.

51. A computer-readable information rec ording medium for storing a program for causing a computer to perform, in communications between a plurality of communications networks having different address systems, a filtering function of:
determining one of a plurality of address conversion parts for causing the thus-determined one address conversion part to perform address conversion between the different address systems in communications made between the plurality of communications networks.

52. The information recording medium as claimed in claim 51, wherein said program further causes the computer to perform a communications function of communicating processing load conditions of the respective address conversion parts,
wherein, in said filtering function, load sharing rates on the respective address conversion apparatuses are controlled for every occasion of communications according to the processing load conditions of the respective address conversion parts thus obtained by said communications function.
